(19) United States
(12) Patent Application Publication
(10) Pub. No.: US 2026/0071917 A1
(43) Pub. Date: Mar. 12, 2026

(54) ELEMENT ARRAY CIRCUIT, METHOD FOR CONTROLLING ELEMENT ARRAY CIRCUIT, AND ELECTROMAGNETIC WAVE SENSOR INCLUDING ELEMENT ARRAY CIRCUIT

(71) Applicant: TDK Corporation, Tokyo (JP)

(72) Inventors: Tadao SENRIUCHI, Tokyo (JP); Naoki OHTA, Tokyo (JP); Shinji HARA, Tokyo (JP)

(73) Assignee: TDK Corporation, Tokyo (JP)

(21) Appl. No.: 19/319,442

(22) Filed: Sep. 4, 2025

(30) Foreign Application Priority Data
Sep. 6, 2024 (JP) 2024-153740

(51) Int. Cl. G01J 5/24; G01J 5/02; G01J 5/061; G01J 5/20

(52) U.S. Cl. CPC G01J 5/24; G01J 5/026; G01J 5/061; G01J 2005/063; G01J 2005/202

(57) ABSTRACT

An element array circuit includes a row line, a column line, a thermistor element connected to the row and column lines, power supplies connected to the row line, and control units connected to the row and column lines. A control unit maintains the thermistor element at a temperature within a specified range, acquires a base output value output via the column line, acquires a measured output value output via the column line, and obtains a difference between the measured output value and the base output value.

### CROSS-REFERENCE TO RELATED APPLICATIONS

The present application claims priority from Japanese Patent Application No. 2024-153740 filed on Sep. 6, 2024, the entire contents of which are hereby incorporated by reference.

### FIELD

The present disclosure relates to an element array circuit, and particularly to an element array circuit in which thermistor elements are disposed in an array, a method for controlling the element array circuit, and an electromagnetic wave sensor including the element array circuit.

### BACKGROUND

Conventionally, a technology has been known in which a resistive element array circuit having resistive elements arranged in a matrix pattern is used as, for example, an infrared detection circuit (see, e.g., Patent Publication JP-A-H08-94443). In this infrared detection circuit, infrared-sensitive resistors, such as thermistor elements, the resistance values of which vary in accordance with temperature changes, are arranged.

Meanwhile, the resistance values of thermistor elements may generally vary significantly depending on the ambient temperature. As a result, in conventional element array circuits, circuits for reading and processing output signals tend to become complex in order to read the output signals correspondingly with the wide range of resistance values of thermistor elements. In particular, when the signals from the thermistor elements are amplified and output by operational amplifiers or the like, the gain between the input and output voltages fluctuates greatly due to the influence of the ambient temperature. Therefore, there has been a concern that the circuitry or computational processing required to correct such fluctuations become extremely complex.

### SUMMARY

An aspect of an element array circuit according to the present disclosure includes: first wiring lines (i.e., row lines or feeding lines) extending in a first direction; one or more second wiring lines (i.e., column lines or reading lines) extending in a second direction; first thermistor elements, each of which is connected to one of the first wiring lines and to one of the second wiring lines; a first power supply configured to supply a first potential; a second power supply configured to supply a second potential different from the first potential; and a control unit.

Then, the control unit, as a “temperature control operation” maintains the first thermistor elements at a temperature within a specified range, by supplying a current to the first thermistor elements through application of the first potential to the first wiring lines and adjusting the first potential, in a state in which the first thermistor elements are not irradiated with electromagnetic waves from a measurement target. Furthermore, the control unit, as a “base output value acquisition operation” acquires a base output value output via the second wiring line, by applying the adjusted first potential to the first wiring lines, in a state in which the first thermistor elements are irradiated with the electromagnetic waves from the measurement target. In addition, the control unit acquires as a “measurement operation” a measured output value output via the second wiring line, by applying the second potential to one first wiring line selected from among the first wiring lines and applying the adjusted first potential to the first wiring lines other than the selected one first wiring line, in a state in which the first thermistor elements are irradiated with the electromagnetic waves from the measurement target. Moreover, the control unit as a “measured output value correction operation” obtains a difference between the measured output value and the base output value.

Furthermore, an aspect of an element array circuit according to the present disclosure may include: one first wiring line extending in a first direction; one or more second wiring lines extending in a second direction; one or more first thermistor elements, each of which is connected to the one first wiring line and to one of the second wiring lines; a first power supply configured to supply a first potential; a second power supply configured to supply a second potential different from the first potential; and a control unit.

Then, the control unit maintains, as a “temperature control operation”, the first thermistor elements at a temperature within a specified range, by supplying a current to the first thermistor elements through application of the first potential to the one first wiring line and adjusting the first potential, in a state in which the first thermistor elements are not irradiated with electromagnetic waves from a measurement target. Furthermore, the control unit acquires, as a “base output value acquisition operation”, a base output value output via the second wiring line, by applying the adjusted first potential to the one first wiring line, in a state in which the first thermistor elements are irradiated with the electromagnetic waves from the measurement target. In addition, the control unit acquires, as a “measurement operation”, a measured output value output via the second wiring line, by applying the second potential to the one first wiring line, in a state in which the first thermistor elements are irradiated with the electromagnetic waves from the measurement target. Moreover, the control unit, as a “measured output value correction operation”, obtains a difference between the measured output value and the base output value.

Alternatively, an aspect of an element array circuit according to the present disclosure may include: first wiring lines extending in a first direction; one or more second wiring lines extending in a second direction; a third wiring line extending in the second direction; first thermistor elements, each of which is connected to one of the first wiring lines and to one of the second wiring lines; second thermistor elements, each of which is connected to one of the first wiring lines and to the third wiring line and is shielded from electromagnetic waves from a measurement target; a first power supply configured to supply a first potential; a second power supply configured to supply a second potential different from the first potential; and a control unit.

Then, the control unit maintains, as a “temperature control operation”, the first thermistor elements and the second thermistor elements at a temperature within a specified range, by supplying a current to the first thermistor elements and the second thermistor elements through application of the first potential to the first wiring lines and adjusting the first potential, in a state in which the first thermistor elements are not irradiated with the electromagnetic waves from the measurement target. Furthermore, the control unit, as a “base output value acquisition operation”, acquires a differential base output value resulting from a difference between a first base output value output via the second wiring line and a second base output value output via the third wiring line, by applying the adjusted first potential to the first wiring lines, in a state in which the first thermistor elements are irradiated with the electromagnetic waves from the measurement target. In addition, the control unit, as a “measurement operation”, acquires a differential measured output value resulting from a difference between a first measured output value output via the second wiring line and a second measured output value output via the third wiring line, by applying the second potential to one first wiring line selected from among the first wiring lines and applying the adjusted first potential to the first wiring lines other than the selected one first wiring line, in a state in which the first thermistor elements are irradiated with the electromagnetic waves from the measurement target. Moreover, the control unit obtains, as a “measured output value correction operation”, a difference between the differential measured output value and the differential base output value.

Furthermore, an aspect of an element array circuit according to the present disclosure may include: one first wiring line extending in a first direction; one or more second wiring lines extending in a second direction; a third wiring line extending in the second direction; one or more first thermistor elements, each of which is connected to the one first wiring line and to one of the second wiring lines; a second thermistor element that is connected to the one first wiring line and the third wiring line and is shielded from electromagnetic waves from a measurement target; a first power supply configured to supply a first potential; a second power supply configured to supply a second potential different from the first potential; and a control unit.

Then, the control unit, as a “temperature control operation”, maintains the first thermistor elements and the second thermistor element at a temperature within a specified range, by supplying a current to the first thermistor elements and the second thermistor element through application of the first potential to the one first wiring line and adjusting the first potential, in a state in which the first thermistor elements are not irradiated with the electromagnetic waves from the measurement target. Furthermore, the control unit, as a “base output value acquisition operation”, acquires a differential base output value resulting from a difference between a first base output value output via the second wiring line and a second base output value output via the third wiring line by applying the adjusted first potential to the one first wiring line, in a state in which the first thermistor elements are irradiated with the electromagnetic waves from the measurement target. In addition, the control unit, as a “measurement operation”, acquires a differential measured output value resulting from a difference between a first measured output value output via the second wiring line and a second measured output value output via the third wiring line by applying the second potential to the one first wiring line, in a state in which the first thermistor elements are irradiated with the electromagnetic waves from the measurement target. Moreover, the control unit, as a “measured output value correction operation”, obtains a difference between the differential measured output value and the differential base output value.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is a circuit diagram schematically showing an example of the configuration of an element array circuit according to a first example embodiment of the present disclosure;

FIG. 2 is a cross-sectional view schematically showing the schematic configuration of an example of an electromagnetic wave sensor including the element array circuit according to the present disclosure;

FIG. 3 is a flowchart showing the outline of an example of the operation of the electromagnetic wave sensor according to the present disclosure;

FIG. 4 is a flowchart showing a part of an example of the operation of the element array circuit according to the present disclosure;

FIG. 5 is a flowchart showing a part of an example of the operation of the element array circuit according to the present disclosure;

FIG. 6 is a flowchart showing a part of an example of the operation of the element array circuit according to the present disclosure;

FIG. 7 is a flowchart showing a part of an example of the operation of the element array circuit according to the present disclosure;

FIG. 8 is a circuit diagram schematically showing an example of the configuration of the element array circuit according to a second example embodiment of the present disclosure;

FIG. 9 is a circuit diagram schematically showing an example of the configuration of the element array circuit according to a third example embodiment of the present disclosure;

FIG. 10 is a flowchart showing a part of an example of the operation of the element array circuit according to the present disclosure;

FIG. 11 is a flowchart showing a part of an example of the operation of the element array circuit according to the present disclosure;

FIG. 12 is a flowchart showing the outline of another example of the operation of the electromagnetic wave sensor according to the present disclosure;

FIG. 13 is a flowchart showing a part of an example of the operation of the element array circuit according to the present disclosure;

FIG. 14 is a flowchart showing a part of an example of the operation of the element array circuit according to the present disclosure;

FIG. 15 is a flowchart showing a part of an example of the operation of the element array circuit according to the present disclosure;

FIG. 16 is a circuit diagram schematically showing an example of the configuration of the element array circuit according to a fifth example embodiment of the present disclosure;

FIG. 17 is a circuit diagram schematically showing an example of the configuration of the element array circuit according to a sixth example embodiment of the present disclosure;

FIG. 18 is a circuit diagram schematically showing an example of the configuration of the element array circuit according to a seventh example embodiment of the present disclosure;

FIG. 19 is a circuit diagram schematically showing an example of the configuration of the element array circuit according to an eighth example embodiment of the present disclosure; and

FIG. 20 is a circuit diagram schematically showing an example of the configuration of the element array circuit according to a ninth example embodiment of the present disclosure.

### DETAILED DESCRIPTION

It is desirable to provide an element array circuit capable of measuring electromagnetic waves under a wide range of ambient temperature conditions while reducing the complexity of a circuit for reading and processing output signals, a method for controlling the element array circuit, and an electromagnetic wave sensor including the element array circuit.

In the following, some example embodiments and modification examples of the technology are described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions.

Hereinafter, the example embodiments will be described with reference to the accompanying drawings. In order to facilitate understanding of the description, the same components in each drawing are denoted by the same reference numerals as much as possible, and their redundant descriptions will be omitted.

### First Example Embodiment

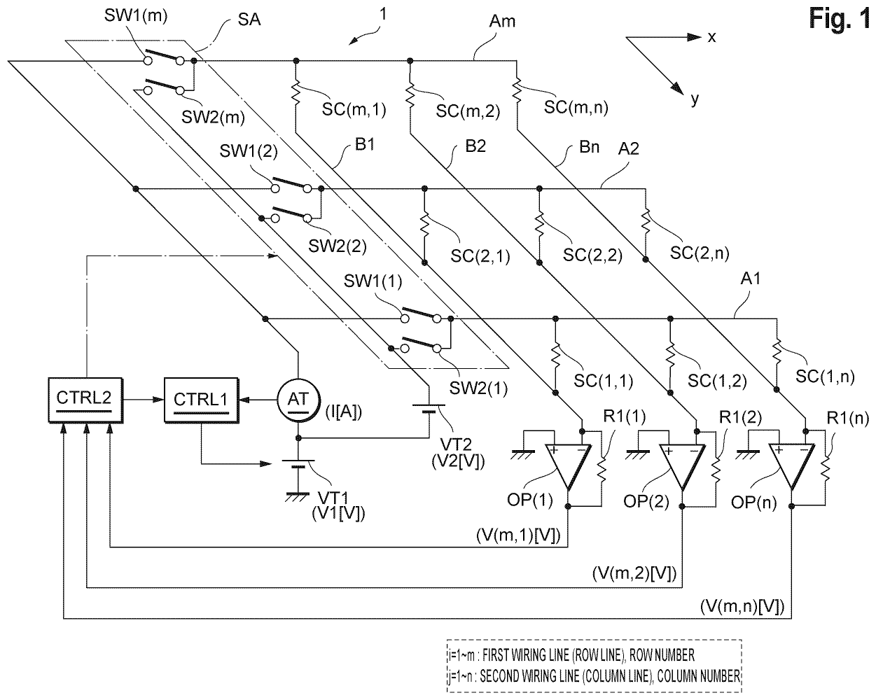

FIG. 1 is a circuit diagram schematically showing an example of the configuration of an element array circuit according to a first example embodiment of the present disclosure. The element array circuit 1 is mounted in, for example, a far-infrared thermographic device and is configured to output a voltage corresponding to the intensity of electromagnetic waves, such as infrared rays, applied onto the element array circuit 1.

As shown in FIG. 1, the element array circuit 1 includes row lines Ai (i=an integer of 1 to m; the same applies hereinafter), column lines Bj (j=an integer of 1 to n; the same applies hereinafter), thermistor elements SC(i, j), operational amplifiers OP(j), resistors R1(j), a row line selection unit SA having switches SW1(m) and switches SW2(m), an ammeter AT, power supplies VT1 and VT2, a first control unit CTRL1, and a second control unit CTRL2. Note that the subscripts of the thermistor elements SC(i, j) indicate that the thermistor elements are connected to both the i-th row line Ai among the m row lines A1 to Am and the j-th column line Bj among the n column lines B1 to Bn. Furthermore, the row lines Ai and the column lines Bj are not in direct contact with each other.

### Row Line A

The row line Ai is an example of a “first wiring line” according to the present disclosure and functions as a power feeding line to each thermistor element SC(i, j). Each row line Ai extends in a first direction (i.e., the x-axis direction in the figure), and the row lines Ai are arranged in parallel at specified intervals in a second direction (i.e., the y-axis direction in the figure). The second direction is a direction different from the first direction. Furthermore, one end of each of the thermistor elements SC(i, j) is connected to each row line Ai. In the example shown in FIG. 1, the n thermistor elements SC(i, j) are connected in parallel to each row line Ai. For example, one end (i.e., the upper end in the figure) of each of the thermistor elements SC(1, 1) to SC(1, n) arranged in the x-axis direction is connected to the row line A1 extending in the x-axis direction. Similarly, one end of each of the thermistor elements SC(2, 1) to SC(2, n) arranged in the x-axis direction is connected to the row line A2 extending in the x-axis direction, and one end of each of the thermistor elements SC(m, 1) to SC(m, n) arranged in the x-axis direction is connected to the row line Am extending in the x-axis direction. In the example shown in FIG. 1, one end (i.e., the right end in the figure) of each row line Ai is connected to one end of each of the thermistor elements SC(i, n). Furthermore, the other end (i.e., the left end in the figure) of each row line Ai is connected to the ammeter AT, which will be described later.

### Column Line B

The column line Bj is an example of a “second wiring line” according to the present disclosure and functions as a read line for reading a current corresponding to the resistance value of each thermistor element SC(i, j). Each column line Bj extends in a second direction (i.e., the y-axis direction in the figure), and the column lines Bj are arranged in parallel at specified intervals in the first direction (i.e., the x-axis direction in the figure). Furthermore, the other end of each of the thermistor elements SC(i, j) is connected to each column line Bj. In the example shown in FIG. 1, the m thermistor elements SC(i, j) are connected in parallel to each column line Bj. For example, the other end (i.e., the lower end in the figure) of each of the thermistor elements SC(1, 1) to SC(m, 1) arranged in the y-axis direction is connected to the column line B1 extending in the y-axis direction. Similarly, the other end of each of the thermistor elements SC(1, 2) to SC(m, 2) arranged in the y-axis direction is connected to the column line B2 extending in the y-axis direction, and the other end of each of the thermistor elements SC(1, m) to SC(m, n) arranged in the y-axis direction is connected to the column line Bn extending in the y-axis direction. In the example shown in FIG. 1, one end (i.e., the upper end in the figure) of each column line Bj is connected to the other end of the thermistor element SC(m, j). Furthermore, the other end (i.e., the lower end in the figure) of each column line Bj is connected to the negative input terminal of the operational amplifier OP(j), which will be described later.

### Thermistor Element SC

The thermistor element SC(i, j) is an example of a “first thermistor element” according to the present disclosure. As described above, each thermistor element SC(i, j) is connected to both the row line Ai and the column line Bj. That is, in the example shown in FIG. 1, the n thermistor elements SC(i, 1) to SC(i, n) are connected in parallel to each row line Ai, and the m thermistor elements SC(1, j) to SC(m, j) are connected to each column line Bj. Note that only one thermistor element SC(i, j) is connected to both each row line Ai and each column line Bj. Accordingly, by selecting one of the row lines Ai and one of the column lines Bj, a single thermistor element SC(i, j) may be specified (selected).

Here, the thermistor element SC(i, j) is a light-receiving element that converts electromagnetic waves, such as infrared rays or far-infrared rays, collected by a lens or the like into an electrical signal. For example, the thermistor element SC(i, j) may include a thermistor film, which serves as a resistance change layer that exhibits a change in resistance due to, for example, a change in temperature. Examples of the thermistor film may include those containing vanadium oxide, amorphous silicon, polycrystalline silicon, a spinel-type crystal structure oxide containing manganese, or yttrium-barium-copper oxide. Furthermore, an electromagnetic-wave absorption layer, which absorbs electromagnetic waves to generate heat, is provided adjacent to the thermistor film. The electromagnetic-wave absorption layer may contain, for example, silicon oxide (SiO₂), aluminum oxide (Al₂O₃), silicon nitride (Si₃N₄), aluminum nitride (AlN), or the like. With these configurations, the thermistor element SC(i, j) causes a change in the temperature of the electromagnetic-wave absorption layer and a change in the temperature of the resistance change layer in accordance with the intensity of the received electromagnetic waves. As a result, the thermistor element SC(i, j) functions such that the resistance value of the resistance change layer varies.

### Operational Amplifier OP

The operational amplifier OP(j) includes a positive input terminal, a negative input terminal, and an output terminal. Among these terminals, the positive input terminal is connected to a specified potential. Note that the “specified potential” is not particularly limited here as long as it differs from a first potential of V1, a second potential of V1+V2, and a third potential of V1+V3, which will be described later. In the following description, the specified potential will be treated as a ground potential (zero). Furthermore, as described above, the other end of each corresponding column line Bj is connected to the negative input terminal of each operational amplifier OP(j). In addition, the output terminal of each operational amplifier OP(j) is connected to the control unit CTRL2, which will be described later. The operational amplifier OP(j) operates such that the positive input terminal and the negative input terminal have the same potential. Furthermore, in conjunction with the resistor R1(j) described later, each operational amplifier OP(j) functions as a read circuit that converts a current flowing through the corresponding column line Bj into a voltage and outputs the converted voltage.

### Resistor R1

One end (i.e., the upper end in the figure) of each resistor R1(j) is connected to the column line Bj connected to the negative input terminal of each operational amplifier OP(j). Furthermore, the other end (i.e., the lower end in the figure) of each resistor R1(j) is connected to a signal line extending from the output terminal of the corresponding operational amplifier OP(j). In the example shown in FIG. 1, the resistor R1(j) is connected in parallel to each operational amplifier OP(j) arranged in the x-axis direction. For example, the resistor R1(1) is provided for the operational amplifier OP(1) connected to the column line B1, the resistor R1(2) is provided for the operational amplifier OP(2) connected to the column line B2, and the resistor R1(n) is provided for the operational amplifier OP(n) connected to the column line Bn.

### Row Line Selection Unit SA

The row line selection unit SA has switches SW1(i) and switches SW2(i). These switches SW1(i) and SW2(i) are capable of switching between a conductive state and a non-conductive state. Furthermore, each switch SW1(i) is provided at the other end (i.e., the left end in the figure) of each row line Ai and is collectively connected to the power supply VT1 via the ammeter AT. When the switch SW1(i) is closed, the potential V1 is applied to each row line Ai from the power supply VT1. The power supply VT1 is an example of a “first power supply” according to the present disclosure, and the potential V1 is an example of a “first potential” according to the present disclosure. Note that the power supply VT1 is connected to a ground potential. The power supply VT1 is configured to supply the potential V1.

On the other hand, each switch SW2(i) is provided on a branch line from each row line Ai and is collectively connected in series with the power supply VT1 via the power supply VT2. The power supplies VT1 and VT2 are connected in series. The power supply VT2 is an example of “another power supply” according to the present disclosure. When the switch SW2(i) is closed, the potential V1+V2 is applied to each row line Ai from the power supplies VT1 and VT2. In other words, each of the switches SW1(1) to SW1(m) is provided between a corresponding one of the row lines A1 to Am and the power supply VT1, and switches the conduction or non-conduction between the corresponding row line and the power supply VT1. On the other hand, each of the switches SW2(1) to SW2(m) is provided between a corresponding one of the row lines A1 to Am and the power supplies VT1 and VT2 connected in series, and switches the conduction or non-conduction between the corresponding row line and the power supplies VT1 and VT2. A power supply composed of the power supplies VT1 and VT2 connected in series is an example of a “second power supply” according to the present disclosure, and the potential V1+V2 is an example of a “second potential” according to the present disclosure. The power supplies VT1 and VT2 connected in series are configured to supply the potential V1+V2 different from the potential V1.

### Control Units CTRL1 and CTRL2

The control unit CTRL1 is connected to the ammeter AT and the power supply VT1. Furthermore, in a state in which electromagnetic waves from a measurement target are not incident on the thermistor elements SC(1, 1) to SC(m, n), the control unit CTRL1 applies the potential V1 to the row lines A1 to Am to supply a current to the thermistor elements SC(1, 1) to SC(m, n), while performing the “temperature control operation” (which will be described later) on the thermistor elements SC(1, 1) to SC(m, n) by adjusting the power supply VT1 based on the current value I[A] measured by the ammeter AT.

Furthermore, the control unit CTRL2 is connected to the control unit CTRL1, the row line selection unit SA, and each operational amplifier OP(j). Furthermore, in a state in which electromagnetic waves from a measurement target are incident on the thermistor elements SC(1, 1) to SC(m, n), the control unit CTRL2 performs a “base voltage value acquisition operation,” which will be described later, to acquire a correction base voltage value Vbase(j)[V] output from each operational amplifier OP(j), while applying the potential V1 to the row lines A1 to Am. Subsequently, in a state in which the electromagnetic waves from the measurement target are incident on the thermistor elements SC(1, 1) to SC(m, n), the control unit CTRL2 performs a “measurement operation,” which will be described later, to acquire a measured voltage value Vmeas1(i, j)[V] output from each operational amplifier OP(j), while applying the potential V1+V2 to a specific row line Ai and applying the potential V1 to the other row lines A. In addition, the control unit CTRL2 performs a “measured output value correction operation,” which will be described later, to calculate a net voltage value Vcorr(i, j), using a measured voltage value Vmeas1(i, j)[V] and a correction base voltage value Vbase(j)[V]. Moreover, the control unit CTRL2 performs an “image data conversion operation,” which will be described later, to acquire image data indicating the temperature of a measurement target from the finally obtained net voltage value Vcorr(i, j).

The control units CTRL1 and CTRL2 are an example of a “control unit” according to the present disclosure. Note that the control units CTRL1 and CTRL2 are, for example, microcomputers that execute the procedures of the above-described operations, and are configured such that one or more processors, such as CPUs, provided in an computation device perform specified control processing by running a previously stored control program and computation program.

### Example of Operation of Element Array Circuit 1

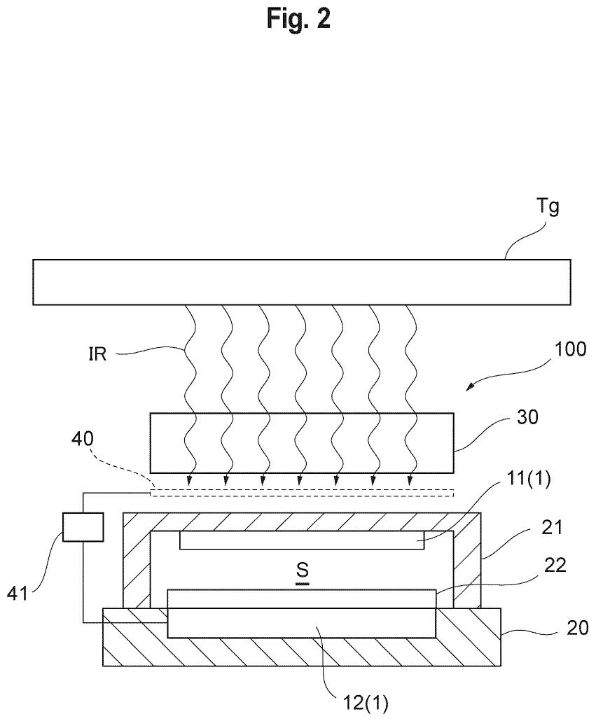

Next, an example of the operation of the element array circuit 1 will be described below. FIG. 2 is a cross-sectional view schematically showing an example of the configuration of an electromagnetic wave sensor including the element array circuit 1 according to the present disclosure. The electromagnetic wave sensor 100 generally includes the element array circuit 1, a base material 20, a housing wall 21, an optical system 30, and a shutter 40 that blocks electromagnetic waves IR emitted from a measurement target Tg. For example, a sensor unit 11, which includes the thermistor elements SC(i, j) of the element array circuit 1, and a getter material 22 for degassing the internal space are accommodated in the internal space S defined by the base material 20 and the housing wall 21. Furthermore, a peripheral circuit unit 12, which includes the control units CTRL1 and CTRL2 and the like of the element array circuit 1, is embedded in the base material 20. In addition, the optical system 30 includes a specified lens and the like and is arranged to be interposed between the sensor unit 11 of the element array circuit 1 and the measurement target Tg. Moreover, the shutter 40 is connected to its drive device 41. The drive device 41 is configured to be connected to the peripheral circuit unit 12 for control.

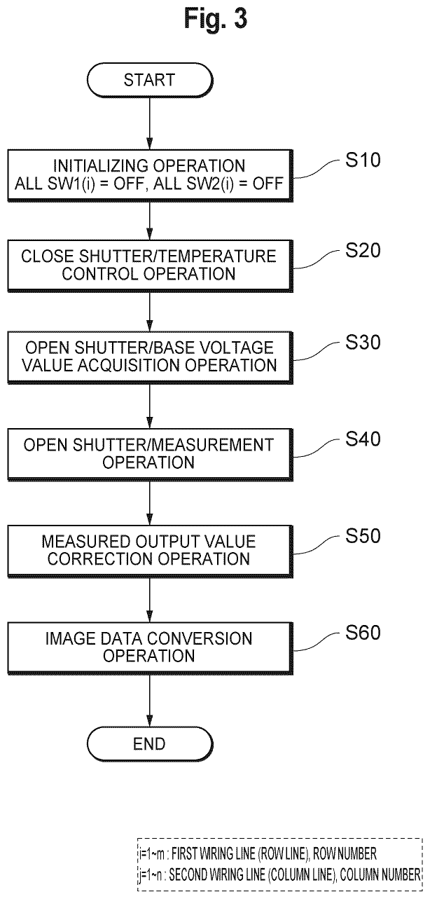

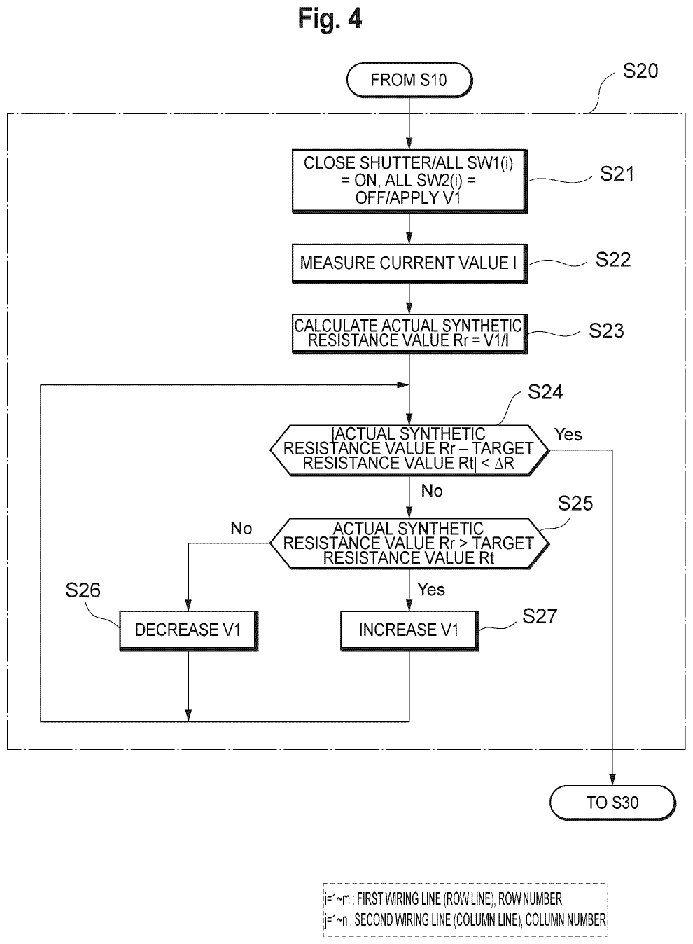

FIG. 3 is a flowchart showing the outline of an example of the operation of the electromagnetic wave sensor 100 according to the present disclosure. FIGS. 4 to 7 are flowcharts each showing a part of the procedure of an example of the operation of the element array circuit 1 according to the present disclosure. As shown in FIG. 3, after the processing starts, the control unit CTRL1 turns off all switches SW1(i) (i.e., opens: non-conductive state) and all switches SW2(i) (i.e., opens: non-conductive state) in step S10 as “an initializing operation.”

Next, in step S20, the control unit CTRL2 closes the shutter 40 so that all the thermistor elements SC(1, 1) to SC(m, n) are not irradiated with the electromagnetic waves IR from the measurement target Tg, thereby performing a “temperature control operation.” As shown in FIG. 4, in step S21, the control unit CTRL2 first turns on (i.e., closes: conductive state) the switches SW1(1) to SW1(m), and turns off (i.e., opens: non-conductive state) the switches SW2(1) to SW2(m). As a result, the potential V1 [V] is applied to all the row lines A1 to Am from the power supply VT1, and currents flow through the thermistor elements SC(1, 1) to SC(m, n) in accordance with the potential differences between the potential at the row lines A1 to Am and the potentials at the negative input terminals of the operational amplifiers OP(j), thereby causing the thermistor elements SC(1, 1) to SC(m, n) to generate heat and increase in temperature.

In addition, in step S22, while the application of the potential V1 to the row lines A1 to Am is continued, the control unit CTRL2 monitors the total amount of the currents flowing through the row lines A1 to Am by the ammeter AT. When an appropriate time has elapsed since step S20 (i.e., after the switches SW1(1) to SW1(m) are turned on and the switches SW2(1) to SW2(m) are turned off), or when a change in the total amount of the currents has become constant within a specified range, or when a specified time has elapsed after the change in the total amount of the current becomes constant within the specified range, the control unit CTRL2 measures and stores the current value I [A] of the total amount of the currents. Next, in step S23, the second control unit CTRL2 calculates the actual synthetic resistance value Rr of the overall thermistor elements SC(1, 1) to SC(m, n) based on the relationship represented by the following Formula (1), using the current value I and the applied potential V1.

$$Actual synthetic resistance value Rr = V 1 / I [ Ω ] \qquad ( 1 )$$

Then, after step S24, the control unit CTRL2 compares a preset and stored target resistance value Rt [Ω] with the actual synthetic resistance value Rr [Ω] calculated in step S23, and appropriately increases or decreases the potential V1 applied from the power supply VT1 on the basis of the value of the difference. That is, in step S24, the control unit CTRL2 determines whether the absolute value of the difference between both values Rr is less than a preset allowable range ΔR [Ω] (i.e., whether the condition represented by the following Formula (2) is satisfied). The allowable range ΔR is, for example, 10% of the target resistance value Rt.

$$\vert Actual synthetic resistance value Rr - target resistance value Rt \vert < Δ R \qquad ( 2 )$$

If “No” in step S24, that is, when the actual synthetic resistance value Rr does not fall within the range of the target resistance value Rt±ΔR, the second control unit CTRL2 further determines, in step S25, the magnitude relationship between the actual synthetic resistance value Rr and the target resistance value Rt on the basis of the condition represented by the following Formula (3).

Actual synthetic resistance value Rr>target resistance value Rt (3)

If “No” in step S25, that is, when the actual synthetic resistance value Rr is too small even when the allowable range ΔR is taken into consideration, the control unit CTRL2 appropriately decreases the potential V1 applied from the power supply VT1 in step S26. On the other hand, if “Yes” in step S25, that is, when the actual synthetic resistance value Rr is too large even when the allowable range ΔR is taken into consideration, the control unit CTRL2 appropriately increases the potential V1 applied from the power supply VT1 in step S27. Then, the control unit CTRL2 returns to the processing of step S24 and repeatedly performs the determination and processing based on the above Formulae (2) and (3). Note that the example shown in FIG. 4 describes a case in which the resistance temperature coefficient of the thermistor elements SC(i, j) is negative (i.e., the thermistor elements SC(i, j) are NTC thermistors). However, in a case in which the resistance temperature coefficient is positive (i.e., the thermistor elements SC(i, j) are PTC thermistors), the control of increasing or decreasing the potential V1 is performed in the reverse order to the above.

On the other hand, if “Yes” in step S24, that is, when the actual synthetic resistance value Rr falls within the range of the target resistance value Rt±ΔR, the control unit CTRL2 completes the processing of the step S20 without changing the potential V1 applied from the power supply VT1 and proceeds to the processing of step S30. As described above, since the actual synthetic resistance value Rr is maintained within the range of the specified target resistance value Rt±ΔR, the applied potential is the adjusted potential V1. Therefore, the temperature due to heat generated by the thermistor elements SC(1, 1) to SC(m, n) may also be maintained within a specified range. The width of the specified temperature range in which the thermistor elements SC(1, 1) to SC(m, n) are maintained is, for example, 20° C. or less, and the specified temperature range in which the thermistor elements SC(1, 1) to SC(m, n) are maintained is, for example, within ±10° C. relative to a specified temperature.

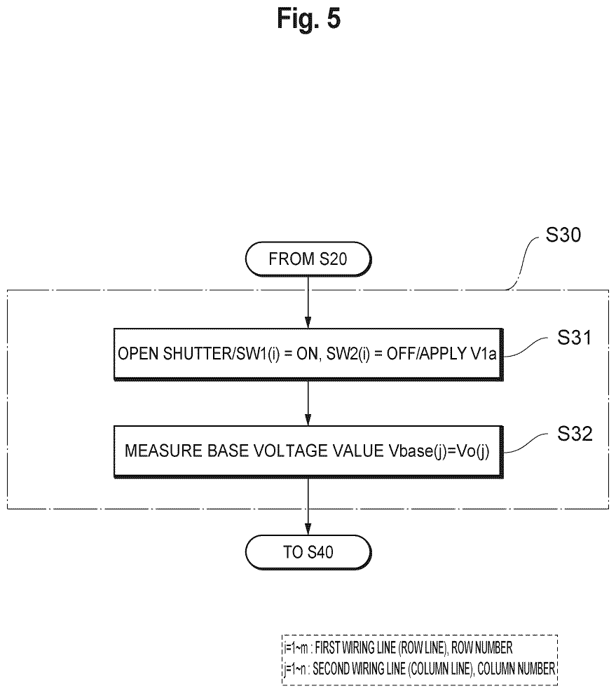

Next, as shown in FIG. 5, in step S30 (or step S31), while maintaining a state in which all the switches SW1(i) are turned on (closed: conductive state) and all the switches SW2(i) are turned off (open: non-conductive state) (a state equivalent to that in step S20) and a state in which the adjusted potential V1 (hereinafter referred to as V1a) is applied to all the row lines A1 to Am from the power supply VT1, the control unit CTRL2 opens the shutter 40 to allow all the thermistor elements SC(1, 1) to SC(m, n) to be irradiated with the electromagnetic waves IR from the measurement target Tg. As a result, the thermistor elements SC(1, 1) to SC(m, n) undergo a temperature change in accordance with the intensity of the applied electromagnetic waves IR relative to the temperature controlled in the step S20. However, since the amount of the temperature change due to the irradiation of the electromagnetic waves IR on the thermistor elements SC(1, 1) to SC(m, n) from the measurement target Tg is small when the shutter 40 is opened, the temperature of the thermistor elements SC(1, 1) to SC(m, n) is maintained at a value within a specified range. In step S30, the control unit CTRL 2 performs a “base voltage value acquisition operation” (which is an example of a “base output value acquisition operation” according to the present disclosure) in this state.

In addition, in step S32, in that state, the control unit CTRL2 measures a voltage value Vo(j)[V] output from each operational amplifier OP(j) and acquires the voltage value Vo(j)[V] as a correction base voltage value Vbase(j) for the thermistor elements SC(1, j) to SC(m, j) connected to the corresponding column line Bj (which is an example of a “base output value” according to the present disclosure). Then, the control unit CTRL2 proceeds to the processing in step S40. The base voltage value Vbase(j) (i.e., the voltage value Vo(j) output from the operational amplifier OP(j)) is an output value output via the column line Bj.

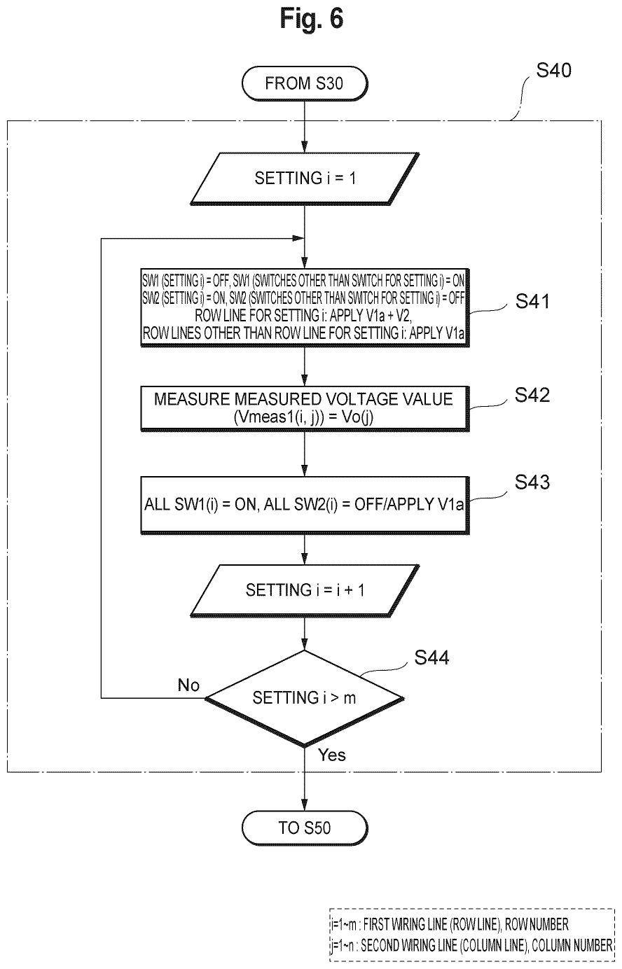

Next, in step S40, the same state as that in step S30, that is, a state in which the control unit CTRL2 opens the shutter 40 such that all the thermistor elements SC(1, 1) to SC(m, n) are irradiated with the electromagnetic waves IR from the measurement target Tg is maintained. In step S40, the control unit CTRL2 performs a “measurement operation” on the measurement target Tg in this state. Also in step 40, the temperature of the thermistor elements SC(1, 1) to SC(m, n) is maintained at a value within a specified range. As shown in FIG. 6, the control unit CTRL 2 first assigns “1” into i (i=1) as definition processing and repeatedly performs the processing in steps S41 to S44 until the subscript i reaches m.

First, in step S41, the control unit CTRL2 turns off the switch SW1 (i.e., the switch for setting i) (open: non-conductive state) and turns on the switches SW1 (i.e., the switches other than the switch for setting i) (closed: conductive state). Furthermore, the control unit CTRL2 turns on the switch SW2 (i.e., the switch for setting i) (closed: conductive state) and turns off the switches SW2 (switches other than the switch for setting i) (open: non-conductive state). As a result, a potential of V1a+V2 is applied to the row line Ai for setting i from the power supplies VT1 and VT2. Here, the row line Ai for setting i is an example of “one first wiring line selected from among first wiring lines” according to the present disclosure. Furthermore, a potential of V1a is applied to the row lines A other than the row line for setting i from the power supply VT1. In addition, in step S42, in that state, the control unit CTRL2 measures a voltage value of Vo(i) [V] output from each operational amplifier OP(j) and acquires the voltage value Vo(j) [V] as a measured voltage value Vmeas1(i, j) corresponding to the thermistor elements SC(i, j) connected to the corresponding column line Bj (which is an example of a “measured output value” according to the present disclosure). The measured voltage value Vmeas1(i, j) (i.e., the voltage value Vo(j) output from the operational amplifier OP(j)) is an output value output via the column line Bj.

Next, in step S43, the control unit CTRL2 turns on all the switches SW1(i) (closed: conductive state) and turns off all the switches SW2(i) (closed: non-conductive state). Then, the control unit CTRL2 increments i by one (i=i+1) as definition processing, and determines in step S44 whether i>m. If “No,” the control unit CTRL2 returns to the processing of step S41. If “Yes,” the control unit CTRL2 proceeds to the processing in step S50.

For example, in steps S41 and S42, when i=1, the control unit CTRL2 first turns off the switch SW1(1), turns on the switches SW1(2) to SW1(m), turns on the switch SW2(1), and turns off the switches SW2(2) to SW2(m). As a result, the potential V1a+V2 is applied to the row line A1, and the potential V1a is applied to the other row lines A2 to Am. Then, measured voltage values Vmeas1(1, 1) to Vmeas1(1, n) corresponding to the thermistor elements SC(1, 1) to SC(1, n) are acquired.

Next, when i=2, the control unit CTRL2 turns off the switch SW1(2), turns on the switches SW1(1) and SW1(3) to SW1(m), turns on the switch SW2(2), and turns off the switch SW2(1) and the switches SW2(3) to SW2(m). As a result, the potential V1a+V2 is applied to the row line A2, and the potential V1a is applied to the other row lines A1 and A3 to Am. Then, measured voltage values Vmeas1(2, 1) to Vmeas1(2, n) corresponding to the thermistor elements SC(2, 1) to SC(2, n) are measured and stored.

Similarly, when i=m, the control unit CTRL2 turns off the switch SW1(m), turns on the switches SW1(1) to SW1(m−1), turns on the switch SW2(m), and turns off the switches SW2(1) to SW2(m−1). As a result, the potential V1a+V2 is applied to the row lines Am, and the potential V1a is applied to the other row lines A1 to Am−1. Then, measured voltage values Vmeas (m, 1) to (m, n) corresponding to the thermistor elements SC(m, 1) to SC(m, n) are measured and stored.

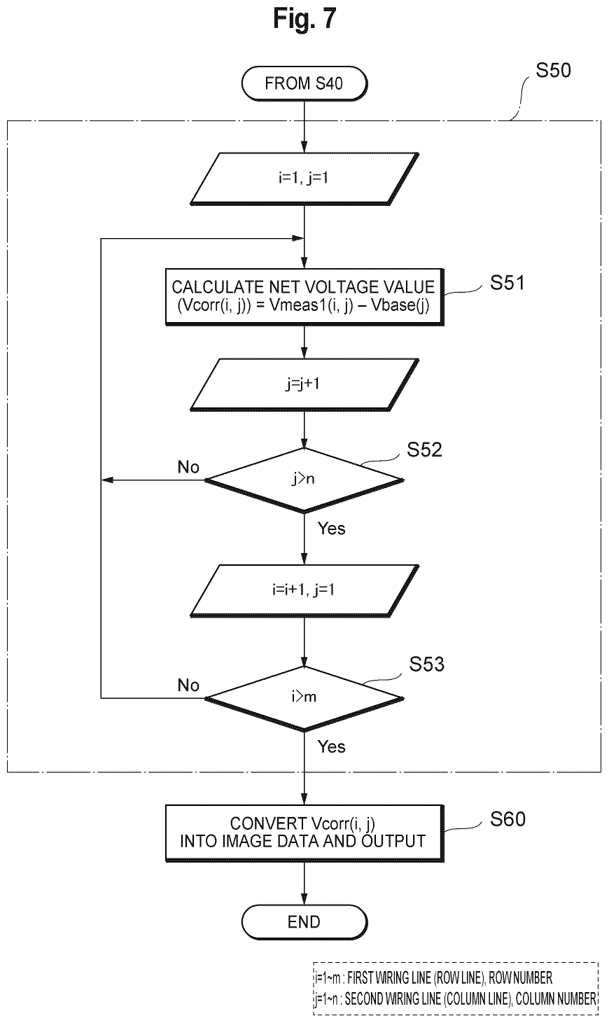

In addition, in step S50, the control unit CTRL2 performs a “measured output value correction operation” as computation processing, using the output values acquired so far. As shown in FIG. 7, the control unit CTRL2 first assigns “1” into i and j (i=1, j=1) as definition processing, and repeatedly performs the processing in steps S51 to S53 until the subscript i reaches m and the subscript j reaches n. In step S51, the control unit CTRL2 obtains the difference between the measured voltage value Vmeas1(i, j) and the base voltage value Vbase(j). For example, in step S51, the control unit CTRL2 subtracts the correction base voltage value Vbase(j), which serves to eliminate the influence caused when the potential V1a is applied to the row lines A1 to Am for temperature adjustment, from the measured voltage value Vmeas1(i, j) obtained when the potential V1a+V2 is applied to the row line Ai for setting i, and the potential V1a is applied to the row lines A other than the row line for setting i. Thus, the control unit CTRL2 calculates a net voltage value Vcorr(i, j), which is the voltage that may be output corresponding to each thermistor element SC(i, j) when the potential V2 is applied to the row line Ai (see the following Formula (4)).

$$Vcorr ( i , j ) = Vmeas 1 ( i , j ) - Vbase ( j ) \qquad ( 4 )$$

Next, the control unit CTRL2 increments j by one as definition processing (j=j+1), and determines in step S52 whether j>n. If “No,” the control unit CTRL2 returns to the processing of step S51. If “Yes,” the control unit CTRL2 increments i by one (i=i+1) and resets j to 1 (j=1) as definition processing. Then, the control unit CTRL2 determines in step S53 whether i>m. If “No,” the control unit CTRL2 returns to the processing of step S51. If “Yes,” the control unit CTRL2 proceeds to the processing in step S60. In step S60, the control unit CTRL2 performs, for example, an “image data conversion operation” to convert the finally obtained net voltage value Vcorr(i, j) into image data representing temperature using an appropriate image conversion processing program or the like. After outputting the image data to an external unit as appropriate, the control unit CTRL2 completes the processing.

Here, in order to further facilitate understanding, the validity of the relationship represented by the above Formula (4) will be illustrated by way of example. For the sake of simplicity, the element array circuit 1 is assumed to have an array of the thermistor elements SC(i, j) arranged in 3 rows and 3 columns (m=3, n=3). Accordingly, when the measured voltage values Vmeas1(i, j), which correspond to the thermistor elements SC(1, 1), SC(1, 2), and SC(1, 3) connected to the row line A1 (i=1) and are measured in steps S41 and S42, are expressed as voltage outputs from the respective operational amplifiers OP(j), they are represented by the following Formulae (5) to (7) according to the characteristics of the operational amplifiers. Note that RR(i) denotes the resistance values of the resistors R1(i), and RS(i, j) denotes the resistance values of the thermistor elements SC(i, j) (the same applies hereinafter).

$$[ Math . 1 ]$$

$$Vmeas 1 ( 1 , 1 ) = \text{} - \frac{RR ( 1 )}{RS ( 1 , 1 )} \times ( V 1 a + V 2 ) - \frac{RR ( 1 )}{RS ( 2 , 1 )} \times V 1 a - \frac{RR ( 1 )}{RS ( 3 , 1 )} \times V 1 a \qquad ( 5 )$$

$$Vmeas 1 ( 1 , 2 ) = \text{} - \frac{RR ( 2 )}{RS ( 1 , 2 )} \times ( V 1 a + V 2 ) - \frac{RR ( 2 )}{RS ( 2 , 2 )} \times V 1 a - \frac{RR ( 2 )}{RS ( 3 , 2 )} \times V 1 a \qquad ( 6 )$$

$$Vmeas 1 ( 1 , 3 ) = \text{} - \frac{RR ( 3 )}{RS ( 1 , 3 )} \times ( V 1 a + V 2 ) - \frac{RR ( 3 )}{RS ( 2 , 3 )} \times V 1 a - \frac{RR ( 3 )}{RS ( 3 , 3 )} \times V 1 a \qquad ( 7 )$$

When summarized for each of the potentials V1a and V2, these measured voltage values are represented by the following Formulae (5′) to (7′).

$$[ Math . 2 ]$$

$$Vmeas 1 ( 1 , 1 ) = \text{} - \frac{RR ( 1 )}{RS ( 1 , 1 )} \times V 2 - \frac{RR ( 1 )}{RS ( 1 , 1 )} \times V 1 a - \frac{RR ( 1 )}{RS ( 2 , 1 )} \times V 1 a - \frac{RR ( 1 )}{RS ( 3 , 1 )} \times V 1 a \qquad ( {5}^{′} )$$

$$Vmeas 1 ( 1 , 2 ) = \text{} - \frac{RR ( 2 )}{RS ( 1 , 2 )} \times V 2 - \frac{RR ( 2 )}{RS ( 1 , 2 )} \times V 1 a - \frac{RR ( 2 )}{RS ( 2 , 2 )} \times V 1 a - \frac{RR ( 2 )}{RS ( 3 , 2 )} \times V 1 a \qquad ( {6}^{′} )$$

$$Vmeas 1 ( 1 , 3 ) = \text{} - \frac{RR ( 3 )}{RS ( 1 , 3 )} \times V 2 - \frac{RR ( 3 )}{RS ( 1 , 3 )} \times V 1 a - \frac{RR ( 3 )}{RS ( 2 , 3 )} \times V 1 a - \frac{RR ( 3 )}{RS ( 3 , 3 )} \times V 1 a \qquad ( {7}^{′} )$$

As described above, the first term on the right side of the above Formulae (5′) to (7′) (i.e., the term multiplied by the potential V2) precisely represents the net voltage values Vcorr(1, 1) to Vcorr(1, 3), which are the voltages that may be output corresponding to the respective thermistor elements SC(1, 1) to SC(1, 3) when the potential V2 is applied to the row line A1. Furthermore, the second to fourth terms on the right side of Formula (5′) (i.e., the linear combination term multiplied by the potential V1a) precisely represent the correction base voltage value Vbase(1), which serves to eliminate the influence caused when the potential V1a is applied to the row lines A1 to A3 for temperature adjustment. Similarly, the second to fourth terms on the right side of Formula (6′) represent the correction base voltage value Vbase(2), and the second to fourth terms on the right side of Formula (7′) represent the correction base voltage value Vbase(3). Accordingly, the relationships illustrated in the above Formulae (5′) to (7′) may collectively be represented by the following Formula (4′). Since this Formula (4′) is equivalent to the above Formula (4), the validity of Formula (4) is understood.

$$Vmeas 1 ( i , j ) = Vcorr ( i , j ) + Vbase ( j ) . \qquad ( {4}^{′} )$$

### Functions And Effects of Element Array Circuit 1

As described above, in the element array circuit 1 according to the first example embodiment and the electromagnetic wave sensor 100 including the element array circuit 1, the control unit CTRL1 adjusts the potential V1 applied to the row lines A1 to Am (i.e., the first wiring lines) prior to imaging the measurement target Tg (i.e., detecting the electromagnetic waves IR), thereby maintaining the thermistor elements SC(1, 1) to SC(m, n) at a temperature within a specified range (temperature control operation).

Then, the control unit CTRL2 applies the adjusted potential V1a to the row lines A1 to Am connected to the thermistor elements SC(1, 1) to SC(m, n), and obtains the correction base voltage values Vbase(j) output from the operational amplifiers OP(j) in a state in which the thermistor elements SC(1, 1) to SC(m, n) are irradiated with the electromagnetic waves IR from the measurement target Tg (base voltage value acquisition operation). Subsequently, the control unit CTRL2 applies the potential V1a+V2 to the row line Ai and the potential V1a to the row lines A other than the row line for setting i, and obtains the measured voltage values Vmeas1(i, j) output from the operational amplifiers OP(j) in a state in which the thermistor elements SC(1, 1) to SC(m, n) are irradiated with the electromagnetic waves IR from the measurement target Tg (measurement operation).

Then, the control unit CTRL2 obtains the differences between the measured voltage values Vmeas1(i, j) and the base voltage values Vbase(j) (measured output value correction operation). As a result, the control unit CTRL2 calculates the net voltage values Vcorr(i, j), which are the voltages that may be output corresponding to the respective thermistor elements SC(i, j) when the potential V2 is applied to the row line Ai. Subsequently, the control unit CTRL2 converts the net voltage values Vcorr(i, j) into image data as appropriate and outputs the image data, thereby visualizing a two-dimensional intensity distribution or the like of the electromagnetic waves IR from the measurement target Tg (e.g., a two-dimensional temperature distribution or the like of the measurement target Tg) (image data conversion operation).

In this manner, the temperature of the thermistor elements SC(i, j), which are used to measure the electromagnetic waves IR from the measurement target Tg, may be easily and accurately maintained within a specified range by adjusting the potential V1 through the temperature control operation performed by the control unit CTRL1. Further, in this state, the control unit CTRL2 measures the electromagnetic waves IR from the measurement target Tg. Therefore, the influence of the ambient temperature at that time may be effectively eliminated, thereby making it possible to measure the electromagnetic waves IR from the measurement target Tg under a wide range of ambient temperature conditions while suppressing the complexity of a circuit for reading and processing output signals.

### Second Example Embodiment

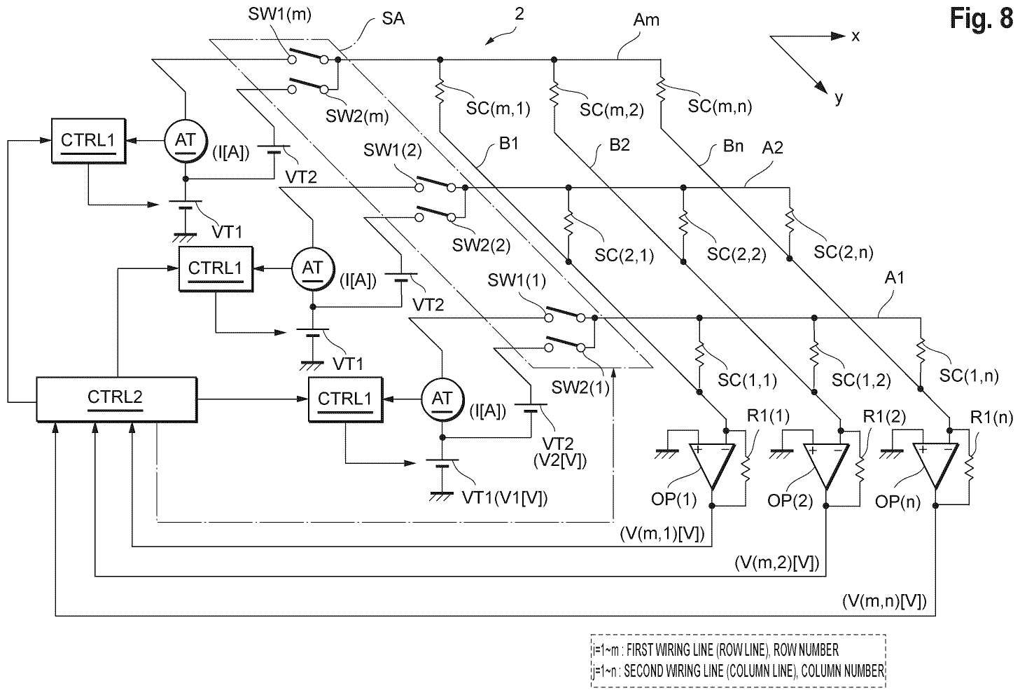

FIG. 8 is a circuit diagram schematically showing an example of the configuration of the element array circuit according to a second example embodiment of the present disclosure. The element array circuit 2 is configured in the same manner as the element array circuit 1 shown in FIG. 1, except that the power supply VT1, the power supply VT2, the ammeter AT, and the control unit CTRL1 are provided for each row line Ai.

The element array circuit 2 configured in this manner and the electromagnetic wave sensor 100 including the element array circuit 2 may also be operated according to substantially the same procedure as that of the flowchart shown in FIG. 3. In addition, the “temperature control operation” performed in step S20 may be performed for each row line Ai individually, rather than for all the row lines A1 to Am collectively. With such a configuration, even if there are slight variations in the temperature resistance characteristics or the like of the thermistor elements SC(i, j), temperature control for the thermistor elements SC(i, j) may be performed more precisely, thereby making it possible to measure the electromagnetic waves IR from the measurement target Tg with higher accuracy.

### Third Example Embodiment

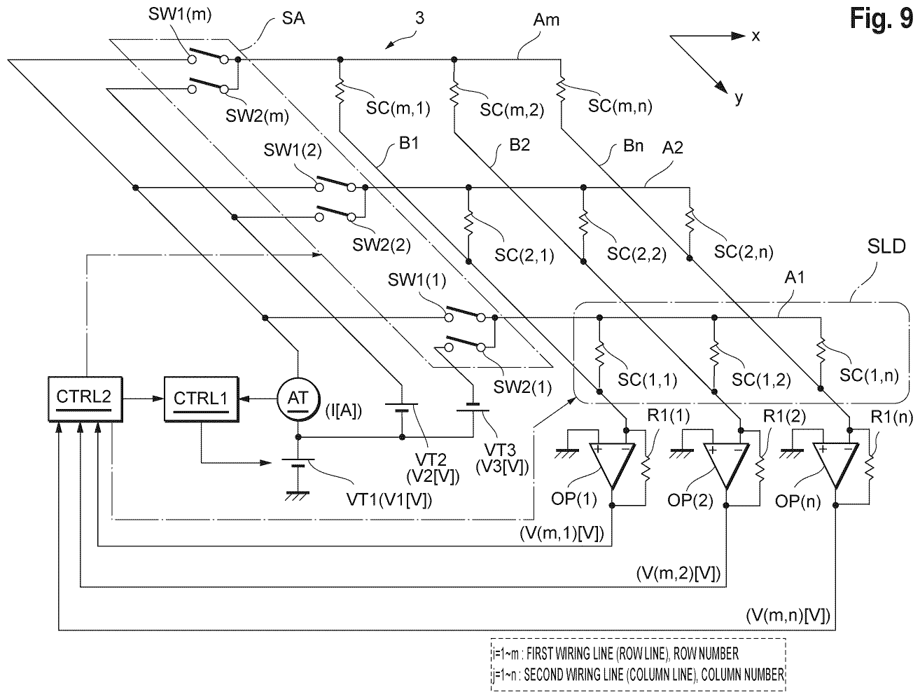

FIG. 9 is a circuit diagram schematically showing an example of the configuration of the element array circuit according to a third example embodiment of the present disclosure. The element array circuit 3 is configured in the same manner as the element array circuit 1 shown in FIG. 1, except that some of the thermistor elements SC(i, j) (here, the thermistor elements SC(1, 1) to SC(1, n) connected to the row line A1) are covered with a shield SLD that blocks the electromagnetic waves IR and are thereby shielded from the electromagnetic waves IR from the measurement target Tg, and that the row line A1 is connected to a power supply VT3, which supplies a potential of V3, instead of the power supply VT2. The power supply VT1 and the power supply VT3 are connected in series. This power supply VT3 is an example of “another power supply” according to the present disclosure. Here, the polarity of the potential V2 and the polarity of the potential V3 are set to be opposite to each other. In other words, the polarity of the potential V2 obtained by subtracting the potential V1 from the potential V1+V2 is set to be opposite to the polarity of the potential V3 obtained by subtracting the potential V1 from a potential of V1+V3. In the third example embodiment, the row line A1 is an example of a “third wiring line extending in the first direction” according to the present disclosure. The row lines A2 to Am are an example of a “first wiring line” according to the present disclosure. The thermistor elements SC(1, 1) to SC(1, n) covered with the shield SLD are an example of a “second thermistor element” according to the present disclosure. The thermistor elements SC(2, 1) to SC(m, n) other than the thermistor elements SC(1,1) to SC(1, n) are an example of a “first thermistor element” according to the present disclosure. The power supplies VT1 and VT3 connected in series are an example of a “third power supply” according to the present disclosure. The potential V1+V3 is an example of a “third potential” according to the present disclosure.

The electromagnetic wave sensor 100 including the element array circuit 3 configured in this manner may also be operated according to substantially the same procedure as that of the flowchart shown in FIG. 3, except that steps S40′ and S50′ are performed instead of steps S40 and S50. In this example embodiment, the polarity of the potential V2 obtained by subtracting the potential V1 from the potential V1+V2 is set to be opposite to the polarity of the potential V3 obtained by subtracting the potential V1 from the potential V1+V3, and the polarity of the potential V2 and the polarity of the potential V3 are set to be opposite to each other. As a result, the influence of self-heating of the thermistor elements SC(i, j) caused by a current (sense current) due to the difference (potential V2) between the potential applied to the row line Ai during the measurement operation of the measurement target Tg in step S40′ and the potential applied to the row line Ai during the base voltage value acquisition operation may be canceled as much as possible. Note that the potential V2 supplied from the power supply VT2 and the potential V3 supplied from the power supply VT3 may be set to have the same absolute value, or may be set to have slightly different absolute values in consideration of individual variations in the characteristics of the thermistor elements SC(i, j) and the output ranges of the operational amplifiers OP(j).

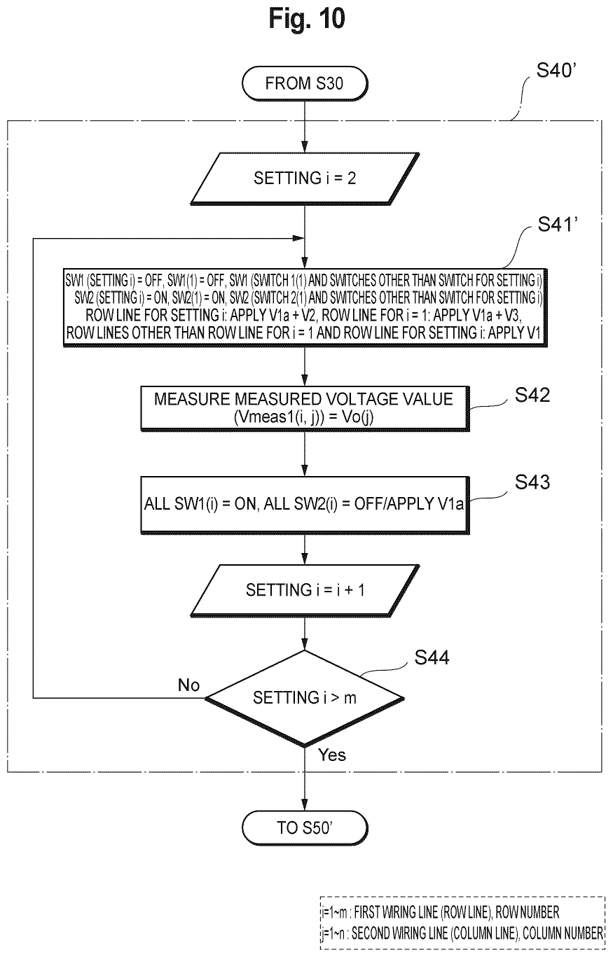

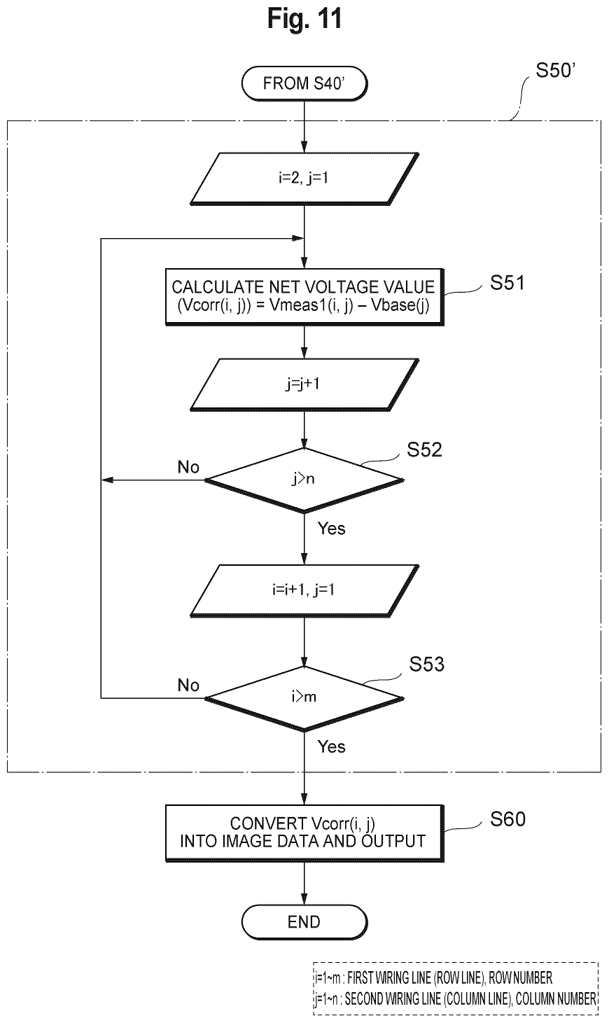

Here, FIGS. 10 and 11 are flowcharts each showing a part of an example of the operation of the element array circuit 3 according to the present disclosure. FIG. 10 shows the outline of step S40′. FIG. 11 shows the outline of step S50′. Step S40′ is substantially the same as the processing in step S40, except that i=2, which corresponds to the first thermistor elements SC(2, 1) to SC(2, n) not covered with the shield SLD, is assigned instead of i=1, which corresponds to the thermistor elements SC(1, 1) to (1, n) covered with the shield SLD, and that step S41′ is performed instead of step S41, as the initial definition processing.

That is, in step S41′, the control unit CTRL2 turns off the switch SW1 (setting i) (open: non-conductive state), turns off the switch SW1(1), which corresponds to i=1 (open: non-conductive state), and turns on the switches SW1(switch 1(1) and switches other than the switch for setting i) (closed: conductive state). Furthermore, the control unit CTRL2 turns on the switch SW2(setting i) (closed: conductive state), turns on the switch SW2(1), which corresponds to i=1 (closed: conductive state), and turns off the switches SW2 (switch 2(1) and switches other than the switch for setting i) (open: non-conductive state). As a result, the potential V1a+V2 is applied to the row line Ai for setting i from the power supplies VT1 and VT2. Furthermore, the potential V1+V3 is applied to the row line A1, which is connected to the thermistors SC(1, 1) to SC(1, n) covered with the shield SLD, from the power supplies VT1 and VT3. In addition, the potential V1a is applied from the power supply VT1 to the row lines A other than the row line A1 for setting i.

Then, acquiring the measured voltage values Vmeas1(i, j), which corresponds to the thermistor element SC(i, j) connected to the respective column lines Bj (where i=2 or more) in step S42, performing the processing in step S43, and performing the setting in step S44 are the same as the processing content in step S40. Furthermore, the processing in step S50′ following step S40′ is substantially the same as the processing in step S50, except that i=2, which corresponds to the first thermistor elements SC(2, 1) to SC(2, n) not covered with the shield SLD, is assigned instead of i=1, which corresponds to the thermistor elements SC(1, 1) to SC(1, n) covered with the shield SLD, as the initial definition processing.

Then, in step S51, the control unit CTRL2 obtains the differences between the measured voltage values Vmeas1(i, j) and the base voltage values Vbase(j) (i≥2). For example, in this example embodiment, in step S51, the control unit CTRL2 subtracts the correction base voltage values Vbase(j), which serve to eliminate the influence caused when the potential V1a is applied to the row lines A1 to Am for temperature adjustment, from the measured voltage values Vmeas1(i, j) obtained when the potential V1a+V2 is applied to the row line Ai (i≥2) for setting i, the potential V1a+V3 is applied to the row line A1, and the potential V1a is applied to the row lines A for settings other than setting i, excluding the row line A1. Then, the control unit CTRL2 sequentially performs the above-described steps S52, S53, and S60 to complete the processing.

Here, as in the first example embodiment, the validity of this example embodiment will also be illustrated by way of example. For the sake of simplicity, the element array circuit 1 is again assumed to have an array of the thermistor elements SC(i, j) arranged in 3 rows and 3 columns (m=3, n=3). Accordingly, when the measured voltage values Vmeas1(i, j), which correspond to the thermistor elements SC(2, 1), SC(2, 2), SC(2, 3) not covered with the shield SLD connected to the row line A2 (i=2) and are measured in steps S41′ and S42, are expressed as voltage outputs from the operational amplifiers OP(j), they are represented by Formulae (8) to (10) according to the characteristics of the operational amplifiers.

$$[ Math . 3 ]$$

$$Vmeas 1 ( 2 , 1 ) = \text{} - \frac{RR ( 1 )}{RS ( 2 , 1 )} \times ( V 1 a + V 2 ) - \frac{RR ( 1 )}{RS ( 1 , 1 )} \times ( V 1 a + V 3 ) - \frac{RR ( 1 )}{RS ( 3 , 1 )} \times V 1 a \qquad ( 8 )$$

$$Vmeas 1 ( 2 , 2 ) = \text{} - \frac{RR ( 2 )}{RS ( 2 , 2 )} \times ( V 1 a + V 2 ) - \frac{RR ( 2 )}{RS ( 1 , 2 )} \times ( V 1 a + V 3 ) - \frac{RR ( 2 )}{RS ( 3 , 2 )} \times V 1 a \qquad ( 9 )$$

$$Vmeas 1 ( 2 , 3 ) = \text{} - \frac{RR ( 3 )}{RS ( 2 , 3 )} \times ( V 1 a + V 2 ) - \frac{RR ( 3 )}{RS ( 1 , 3 )} \times ( V 1 a + V 3 ) - \frac{RR ( 3 )}{RS ( 3 , 3 )} \times V 1 a \qquad ( 10 )$$

When summarized for each of the potentials V1, V2, and V3, these measured voltage values are represented by the following Formulae (8′) to (10′).

$$[ Math . 4 ]$$

$$Vmeas 1 ( 2 , 1 ) = \text{} - \frac{RR ( 1 )}{RS ( 2 , 1 )} \times V 2 - \frac{RR ( 1 )}{RS ( 1 , 1 )} \times V 3 - \frac{RR ( 1 )}{RS ( 2 , 1 )} \times V 1 a - \frac{RR ( 1 )}{RS ( 1 , 1 )} \times V 1 a - \frac{RR ( 1 )}{RS ( 3 , 1 )} \times Va 1 \qquad ( {8}^{′} )$$

$$Vmeas 1 ( 2 , 2 ) = \text{} - \frac{RR ( 2 )}{RS ( 2 , 2 )} \times V 2 - \frac{RR ( 2 )}{RS ( 1 , 2 )} \times V 3 - \frac{RR ( 2 )}{RS ( 2 , 2 )} \times V 1 a - \frac{RR ( 2 )}{RS ( 1 , 2 )} \times V 1 a - \frac{RR ( 2 )}{RS ( 3 , 2 )} \times V 1 a \qquad ( {9}^{′} )$$

$$Vmeas 1 ( 2 , 3 ) = \text{} - \frac{RR ( 3 )}{RS ( 2 , 3 )} \times V 2 - \frac{RR ( 3 )}{RS ( 1 , 3 )} \times V 3 - \frac{RR ( 3 )}{RS ( 2 , 3 )} \times V 1 a - \frac{RR ( 3 )}{RS ( 1 , 3 )} \times V 1 a - \frac{RR ( 3 )}{RS ( 3 , 3 )} \times V 1 a \qquad ( {10}^{′} )$$

As described above, the first term on the right side of the above Formulae (8′) to (10′) (i.e., the term multiplied by the potential V2) precisely represents the net voltage values Vcorr(2, 1) to Vcorr(2, 3), which are the voltages that may be output corresponding to the respective thermistor elements SC(2, 1) to SC(2, 3) not covered with the shield SLD (irradiated with the electromagnetic waves IR) when the potential V2 is applied to the row line A2. Furthermore, the first term on the right side of the same Formulae (i.e., the term multiplied by the potential V2) reflects the influence of both the electromagnetic waves IR and self-heating caused by a current (sense current) due to the difference (potential V2) between the potential applied to the row line A2 during the measurement operation and the potential applied to the row line A2 during the base voltage value acquisition operation. In addition, the second term on the right side of each of the same Formulae (i.e., the term multiplied by the potential V3) represents the net voltage values Vcorr(1, 1) to Vcorr(1, 3), which are the voltages that may be output corresponding to the respective thermistor elements SC(1, 1) to SC(1, 3) covered with the shield SLD (i.e., shielded from the electromagnetic waves IR) when the potential V3 is applied to the row line A1. Furthermore, the second term on the right side of each of the same Formulae (i.e., the term multiplied by the potential V3) reflects the influence of self-heating caused by a current (sense current) due to the difference (potential V3) between the potential applied to the row line A1 during the measurement operation and the potential applied to the row line A1 during the base voltage value acquisition operation. Since the polarity of the potential V2 and the polarity of the potential V3 are opposite to each other, the second term on the right side of each of the same Formulae (i.e., the term multiplied by the potential V3) can be considered as a term that cancels out the influence of self-heating of the thermistor elements SC(i, j) caused by the sense current. Moreover, the third to fifth terms on the right side of Formula (8′) (i.e., the linear combination term multiplied by the potential V1) precisely represent the correction base voltage value Vbase(1), which serves to eliminate the influence caused when the potential V1 is applied to the row lines A1 to A3 for temperature adjustment. Similarly, the third to fifth terms on the right side of Formula (9′) represent the correction base voltage value Vbase(2), and the third to fifth terms on the right side of Formula (10′) represent the correction base voltage value Vbase(3). Accordingly, the relationships illustrated in the above Formulae (8′) to (10′) may be understood as representing a case in which the term that cancels out the influence of self-heating of the thermistor elements SC(i, j) caused by the sense current is added to the above Formula (4′), thereby validating this example embodiment.

According to the element array circuit 3 configured in this manner and the electromagnetic wave sensor 100 including the element array circuit 3, the influence of self-heating of the thermistor elements SC(i, j) caused by the sense current may be canceled out, thereby making it possible to measure the intensity distribution of the electromagnetic waves IR from the measurement target Tg with higher accuracy. Furthermore, the smaller the heat capacity of the thermistor elements SC(i, j), the more sensitively and sharply the electromagnetic waves IR may be detected. However, such thermistor elements SC(i, j) cause a significant amount of heat generation even with the same sense current. Accordingly, even in such a case, by adopting the configuration and operation of this example embodiment, it is possible to achieve the measurement of the electromagnetic waves IR with higher sensitivity and higher accuracy.

### Fourth Example Embodiment

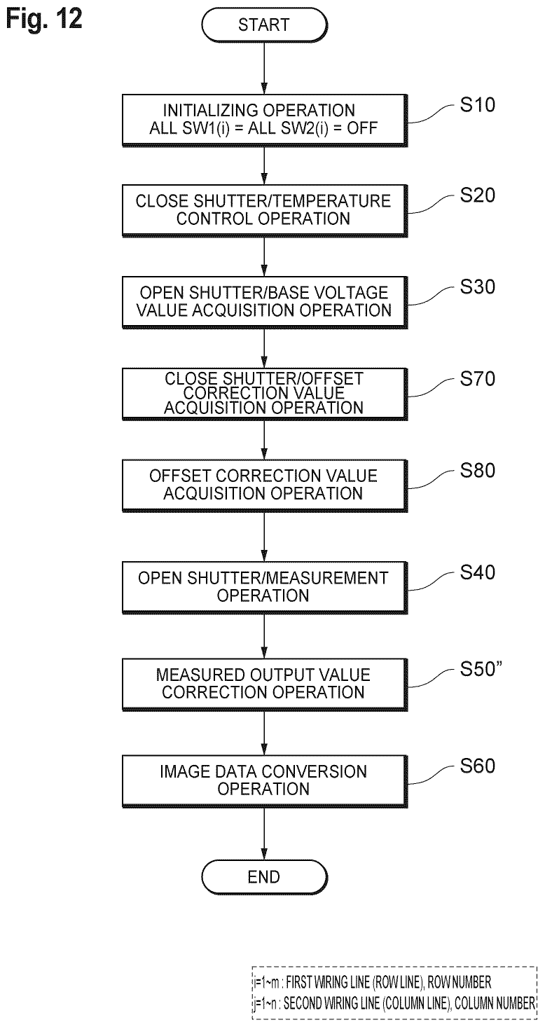

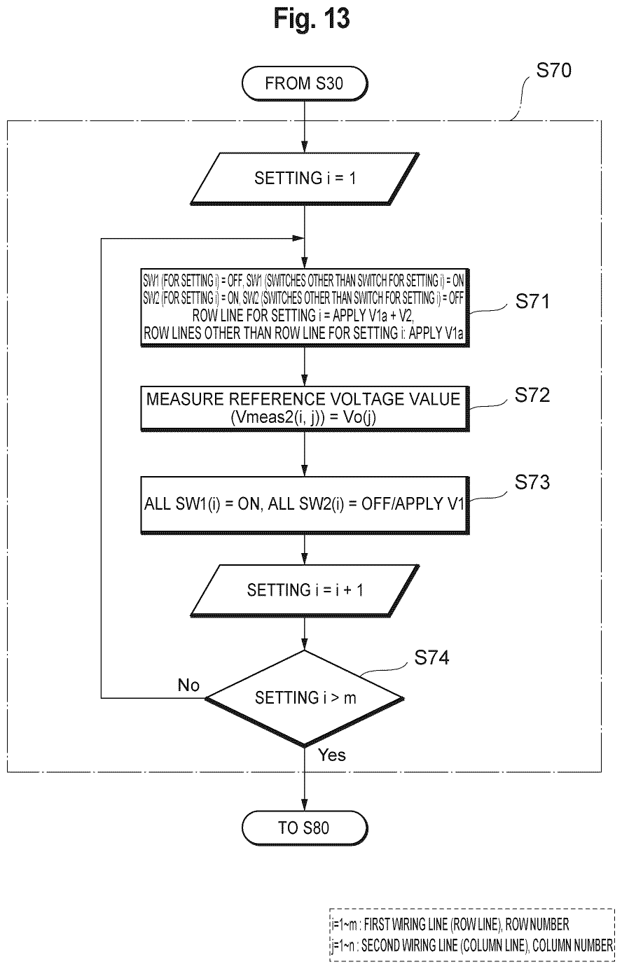

FIG. 12 is a flowchart showing the outline of another example of the operation of the electromagnetic wave sensor 100 according to the present disclosure. FIGS. 13 to 15 are flowcharts each showing a part of the procedure of an example of the operation of the element array circuit 1 according to the present disclosure. As shown in FIG. 12, the electromagnetic wave sensor 100 of this example embodiment may be operated according to substantially the same procedure as the flowchart of the operation example of the electromagnetic wave sensor 100 shown in FIG. 3, except that steps S70 and S80 are performed between steps S30 and S40, and that step S50″ is performed instead of step S50.

Furthermore, as shown in FIGS. 12 and 13, in steps S70 and S80, after the “base voltage value acquisition operation” in step S30, the control unit CTRL2 closes the shutter 40 and performs an “offset correction value acquisition operation” in a state in which the thermistor elements SC(1, 1) to SC(m, n) are irradiated with electromagnetic waves from the shutter 40 having a radiation surface with a substantially uniform temperature (which is an example of a “reference object having a substantially uniform temperature” according to the present disclosure) (i.e., in a state in which all the thermistor elements SC(i, j) are not irradiated with the electromagnetic waves IR from the measurement target Tg). In step 70, the same operation as the measurement operation of step 40 is performed, except that the shutter 40 is closed, and correction offset voltage values Voff (i, j) are acquired on the basis of the result. In step S70, the temperature of the thermistor elements SC(1, 1) to SC(m, n) is maintained at a value within a specified range as in step S40. Note that examples of the shutter 40 that may be used here may include an aluminum plate or the like subjected to black alumite treatment or the like. Furthermore, the “radiation surface having a substantially uniform temperature” refers to a surface in which the overall temperature range (i.e., the difference between maximum and minimum temperature values) falls within the temperature resolution of the electromagnetic wave sensor 100. For example, the surface may be, for example, one in which the overall temperature range (the difference between the maximum and minimum temperature values) is within 0.05° C.

As shown in FIG. 13, in step S70, the control unit CTRL2 first assigns “1” into i (i=1) as definition processing, and repeatedly performs the processing in steps S71 to S74 until the subscript i reaches m. First, in step S71, the control unit CTRL2 performs the same processing as that in step S41 shown in FIG. 6. Then, in step S72, the control unit CTRL2 measures a voltage value of Vo(j)[V] output from each operational amplifier OP(j), and acquires the voltage value Vo(j)[V] as a reference voltage value of Vmeas2(i, j) corresponding to the thermistor element SC(i, j) connected to the corresponding column line Bj in substantially the same manner as in step S42 shown in FIG. 6. Next, in step S73, the control unit CTRL2 turns on all the switches SW1(i) (closed: conductive state) and turns off all the switches SW2(i) (closed: non-conductive state) in the same manner as in step S43 shown in FIG. 6. Then, the control unit CTRL2 increments i by one (i=i+1) as definition processing, and determines in step S74 whether i>m. If “No,” the control unit CTRL2 returns to the processing of step S71. If “Yes,” the control unit CTRL2 proceeds to the processing in step S80.

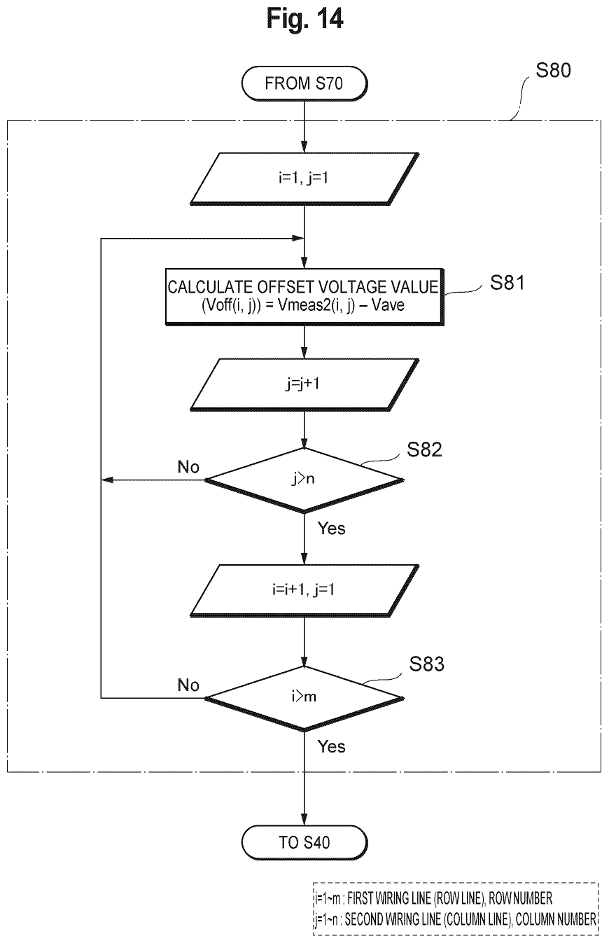

In addition, in step S80, as shown in FIG. 14, the control unit CTRL2 first assigns “1” into i and j (i=1, j=1) as definition processing, and repeatedly performs the processing in steps S81 to S83 until the subscript i reaches m and the subscript j reaches n. That is, in step S81, the control unit CTRL2 obtains the difference between the reference voltage value Vmeas2(i, j) corresponding to each thermistor element SC(i, j) when the potential V1a+V2 is applied to the row line Ai and an average value Vave of all the reference voltage values Vmeas2(1, 1) to Vmeas2(m, n), thereby calculating an offset voltage value of Voff(i, j) for offset correction corresponding to each thermistor element SC(i, j) (see the following Formula (11)).

$$Voff ( i , j ) = Vmeas 2 ( i , j ) - Vave \qquad ( 11 )$$

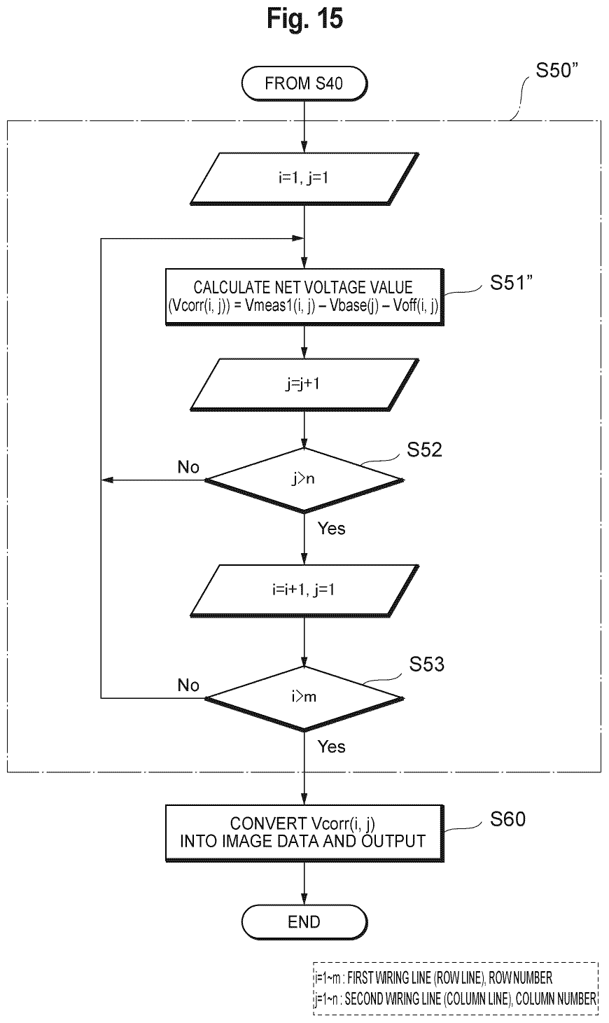

Next, the control unit CTRL2 increments j by one as definition processing (j=j+1), and determines in step S82 whether j>n. If “No,” the control unit CTRL2 returns to the processing of step S81. If “Yes,” the control unit CTRL2 increments i by one (i=i+1) and resets j to 1 (j=1) as definition processing. Then, the second control unit CTRL2 determines in step S83 whether i>m. If “No,” the control unit CTRL2 returns to the processing of step S81. If “Yes,” the control unit CTRL2 proceeds to the processing in step S40 and performs the measurement operation of the measurement target Tg to acquire the measured voltage value Vmeas1(i, j) corresponding to each thermistor element SC(i, j). Then, in step S51″ of step S50″ shown in FIG. 15, the control unit CTRL2 corrects, using the offset voltage values Voff(i, j) acquired in step S80, the differences between the measured voltage values Vmeas1(i, j), which correspond to the respective thermistor elements SC(i, j) when the potential V1a+V2 is applied to the row line Ai for setting i and the potential V1a is applied to the row lines A other than the row line for setting i, and the correction base voltage values Vbase(j), which serve to eliminate the influence caused when the potential V1a is applied to the row lines A1 to Am for temperature adjustment. For example, the control unit CTRL2 subtracts the offset voltage values Voff(i, j) from the differences between the measured voltage values Vmeas1(i, j) and the base voltage values Vbase(j), thereby calculating the net voltage values Vcorr(i, j), which are the voltages that may be output corresponding to the respective thermistor elements SC(i, j) when the potential V2 is applied to the row line Ai (see the following Formula (12)). Then, the above-described steps S52, S53, and S60 are sequentially performed to complete the processing.

$$Vcorr ( i , j ) = Vmeas 1 ( i , j ) - Vbase ( j ) - Voff ( i , j ) \qquad ( 12 )$$

According to the element array circuit 1 configured in this manner and the electromagnetic wave sensor 100 including the element array circuit 1, even if there are manufacturing variations in the resistance values of the thermistor elements SC(i, j), correction is also performed using the offset voltage value Voff (i, j) obtained through actual measurement with a substantially uniform temperature surface, thereby making it possible to reduce measurement errors caused by such individual differences in manufacturing. As a result, the measurement accuracy in electromagnetic wave IR measurement from the measurement target Tg may be further improved.

### Fifth Example Embodiment

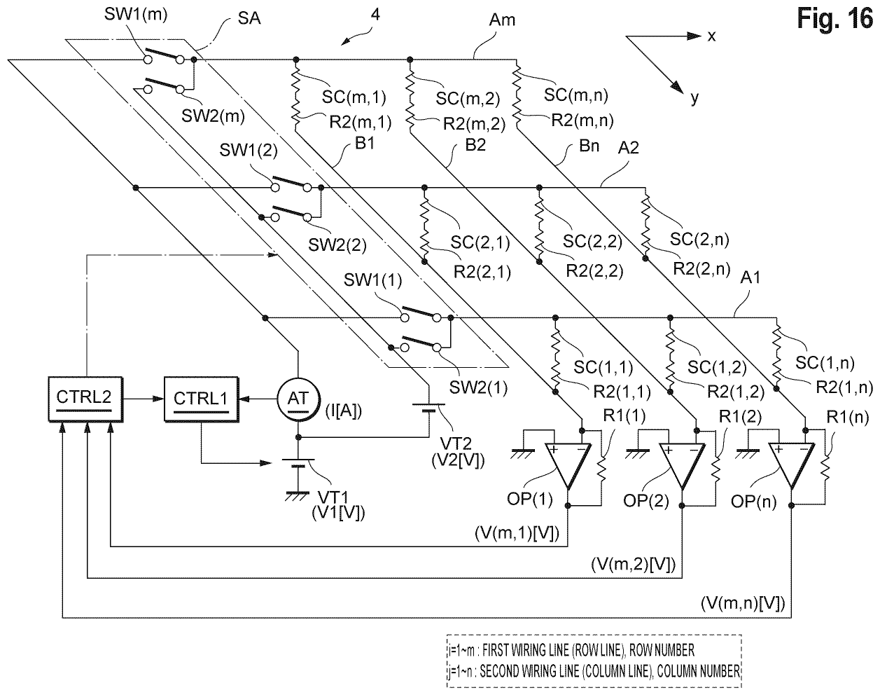

FIG. 16 is a circuit diagram schematically showing an example of the configuration of the element array circuit according to a fifth example embodiment of the present disclosure. The element array circuit 4 is configured in the same manner as the element array circuit 1 shown in FIG. 1, except that it further includes second resistors R2(i, j), each of which is connected in series with a corresponding one of the thermistor elements SC(i, j) and is also connected to a corresponding one of the row lines Ai and a corresponding one of the column lines Bj. The second resistors R2(i, j) are an example of a “resistor” according to the present disclosure.

Generally, if there are manufacturing variations in the resistance values of the thermistor elements SC(i, j), more current tends to flow through the wiring lines (trunk lines) connected to the thermistor elements SC having smaller resistance values. Then, if the thermistor elements SC are NTC thermistors having negative resistance temperature coefficients, due to self-heating thereof the temperature of the thermistor elements SC increases, thus further decreasing resistance values thereof. As a result, even more current concentrates on the trunk lines of the thermistor elements, possibly leading to damage. On the other hand, if the second resistors R2 are connected to the thermistor elements SC as in this example embodiment, they function as negative feedback resistors. As the voltages generated in the second resistors R2 increase, the voltages applied to the thermistor elements SC decrease. As a result, self-heating of the thermistor elements SC is reduced, and the current finally converges into a value that is determined by the balance between the resistance values of both the thermistor elements SC and the second resistors R2, thereby making it is possible to suppress damage to the thermistor elements SC caused by self-heating.

Here, from the viewpoint of allowing the second resistors R2 to function as such negative feedback resistors, the effect of preventing current concentration is sufficiently enhanced when the second resistors R2 have a smaller change ratio of the resistance values with respect to temperature than that of the thermistor elements SC (e.g., 1/100 or less of the change ratio of the thermistor elements SC). Furthermore, even when the resistance values of the second resistors R2 are greater than 1/1000 of those of the thermistor elements SC, the effect of preventing current concentration is sufficiently enhanced. In addition, the resistance values of the second resistors R2 may be smaller than those of the thermistor elements SC. Conversely, if the resistance values of the second resistors R2 are greater than those of the thermistor elements SC, the voltage applied to the thermistor elements SC decreases. As a result, the change ratio due to the electromagnetic waves IR included in the sensor output is reduced, potentially leading to a decrease in sensitivity. Note that the relationship between the second resistors R2 and the thermistor elements SC is defined under room temperature (25° C.) with no voltage applied to any component.

### Sixth Example Embodiment

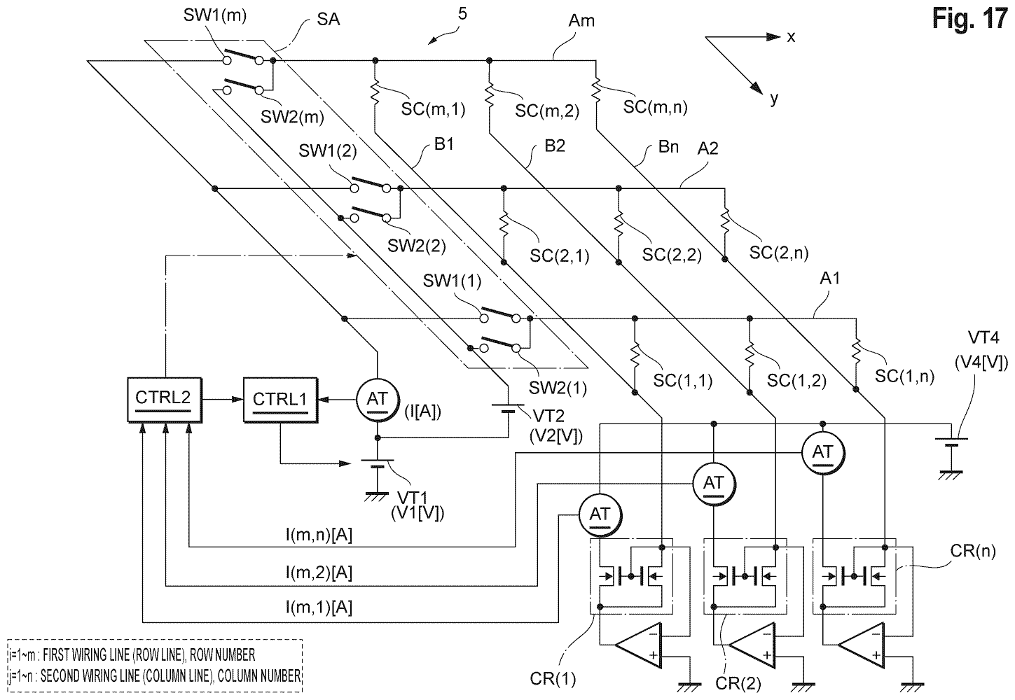

FIG. 17 is a circuit diagram schematically showing an example of the configuration of the element array circuit according to a sixth example embodiment of the present disclosure. The element array circuit 5 is configured in the same manner as the element array circuit 1 shown in FIG. 1, except that it includes current mirror circuits CR(1) to CR(n) and ammeters AT connected between the current mirror circuits CR(j) and the control unit CTRL2 instead of the operational amplifiers OP(1) to OP(n), and that it includes a power supply VT4 that applies a potential of V4 such that one of the two transistors constituting each current mirror circuit CR(j) operates in the saturation region.

In the element array circuit 5 configured in this manner, a “base current value acquisition operation” (which is an example of a “base output value acquisition operation” according to the present disclosure) is performed in step S30 shown in FIGS. 3 and 5 instead of the “base voltage value acquisition operation.” That is, in step S32, the control unit CTRL2 measures a current value of Io(j)[A] output from each current mirror circuit CR(j) via the ammeter AT, and the control unit CTRL2 acquires the current value Io(j)[A] as a correction base current value Ibase(j) (which is an example of a “base output value” according to the present disclosure) for the thermistor elements SC(1, j) to SC(m, j) connected to the corresponding column line Bj. Furthermore, in the “measurement operation” of step S40 shown in FIGS. 3 and 6, the control unit CTRL2 measures the current Io(j)[A] output from each current mirror circuit CR(j) via the ammeter AT, and the control unit CTRL2 acquires the current value Io(j)[A] as a measured current value Imeas1(i, j) (which is an example of a “measured output value” according to the present disclosure) corresponding to the thermistor elements SC(i, j) connected to the corresponding column line Bj.

Then, in the “measured output value correction operation” of step S50 shown in FIGS. 3 and 7, the control unit CTRL2 obtains the difference between a measured current value of Imeas1(i, j) when the potential V1a+V2 is applied to a row line Ai for setting i and the potential V1a is applied to the row lines A other than the row line for setting i, and a correction base current value Ibase(j), which serves to eliminate the influence caused when the potential V1a is applied to the row lines A1 to Am for temperature adjustment, thereby calculating a net current value Icorr(i, j), which is the current that may be output corresponding to each thermistor element SC(i, j) when the potential V2 is applied to the row line Ai (see the following Formula (13).

$$Icorr ( i , j ) = Imeas 1 ( i , j ) - Ibase ( j ) \qquad ( 13 )$$

The element array circuit 5 configured in this manner and the electromagnetic wave sensor 100 including the element array circuit 5 may also easily and accurately maintain the temperature of the thermistor elements SC(i, j), which are used to measure electromagnetic waves IR from the measurement target Tg, within a specified range by adjusting the potential V1 through the temperature control operation performed by the control unit CTRL1. Further, in this state, the control unit CTRL2 measures the electromagnetic waves IR from the measurement target Tg. Therefore, the influence of the ambient temperature at that time may be effectively eliminated, thereby making it possible to measure the electromagnetic waves IR from the measurement target Tg under a wide range of ambient temperature conditions while suppressing the complexity of a circuit for reading and processing output signals.

### Seventh Example Embodiment

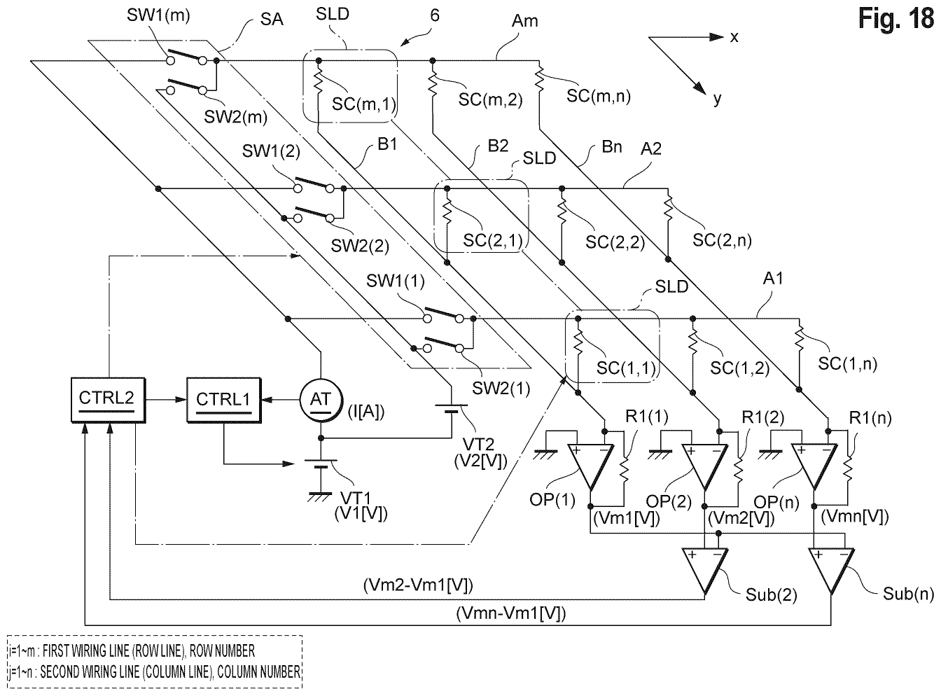

FIG. 18 is a circuit diagram schematically showing an example of the configuration of the element array circuit according to a seventh example embodiment of the present disclosure. The element array circuit 6 is configured in the same manner as the element array circuit 1 shown in FIG. 1, except that some of the thermistor elements SC(i, j) (here, the thermistor elements SC(1, 1) to SC(m, 1) connected to the column line B1) are covered with the shields SLD that block the electromagnetic waves IR and are thereby shielded from the electromagnetic waves IR from the measurement target Tg, and that the element array circuit includes subtraction circuits Sub(2) to Sub(n), which are connected to the operational amplifier OP(1) connected to the column line B1 and the other operational amplifiers OP(2) to OP(n), respectively, the subtraction circuits Sub(2) to Sub(n) being connected to the control unit CTRL2. In the seventh example embodiment and the eighth and ninth example embodiments that will be described later, the column line B1 is an example of a “third wiring line extending in the second direction” according to the present disclosure, the column lines B2 to Bn are an example of a “second wiring line” according to the present disclosure, the thermistor elements SC(1, 1) to SC(m, 1), which are covered with the shields SLD, are an example of a “second thermistor element” according to the present disclosure, and the thermistor elements SC(1, 2) to SC(m, n) other than the thermistor elements SC(1, 1) to SC(m, 1) are an example of a “first thermistor element” according to the present disclosure.

In the element array circuit 6 configured in this manner, the subtraction circuits Sub(2) to Sub(n) output to the control unit CTRL2, the differential voltages between the output voltages of the operational amplifiers OP corresponding to the thermistor elements SC (active cells) not covered with the shields SLD and the output voltage of the operational amplifier OP corresponding to the thermistor elements SC (blind cells) covered with the shields SLD.

Hereinafter, as an example of the operation of the element array circuit 6, a circuit operation will be described in which measurement is performed using the thermistor elements SC(1, 2) and SC(1, 3), which are connected to the row line A1, in an array of the thermistor elements SC(i, j) arranged in 3 rows and 3 columns (m=3, n=3).

Here, in step S30 shown in FIGS. 3 and 5, the control unit CTRL2 first performs a “base correction value acquisition operation” (which is an example of a “base output value acquisition operation” according to the present disclosure) instead of the “base voltage value acquisition operation.” Here, the control unit CTRL2 first turns on the switches SW1(1) to SW1(3), turns off the switches SW2(1) to SW2(m), and applies the adjusted potential V1a to all the row lines A1 to A3 from the power supply VT1, as in step S31 shown in FIG. 5. At this time, the output voltage Vm1 from the operational amplifier OP(1) (i.e., the output corresponding to the blind cells) and the output voltages Vm2 and Vm3 from the operational amplifiers OP(2) and OP(3) (i.e., the outputs corresponding to the active cells) are represented by the following Formulae (14) to (16).

$$[ Math . 5 ]$$

$$Vm 1 = - \frac{R R ( 1 )}{RS ( 1 , 1 )} \times V 1 a - \frac{R R ( 1 )}{R S ( 2 , 1 )} \times V 1 a - \frac{R R ( 1 )}{R S ( 3 , 1 )} \times V 1 a \qquad ( 14 )$$

$$Vm 2 = - \frac{R R ( 2 )}{R S ( 1 , 2 )} \times V1a - \frac{R R ( 2 )}{R S ( 2 , 2 )} \times V 1 a - \frac{R R ( 2 )}{RS ( 3 , 2 )} \times V 1 a \qquad ( 15 )$$

$$Vm 3 = - \frac{R R ( 3 )}{R S ( 1 , 3 )} \times V 1 a - \frac{R R ( 3 )}{R S ( 2 , 3 )} \times V 1 a - \frac{R R ( 3 )}{RS ( 3 , 3 )} \times V 1 a \qquad ( 16 )$$

The voltages Vm2 and Vm3 are the voltage values output via the column lines B2 and B3, respectively (which are an example of a “first base output value” according to the present disclosure), and the voltage Vm1 is the voltage value output via the column line B1 (which are an example of a “second base output value” according to the present disclosure). Further, instead of step S32 shown in FIG. 5, these output voltages Vm1 to Vm3 are input to the subtraction circuits Sub(2) and Sub(3), and the differential voltages Vm2−Vm1 and Vm3−Vm1, which are computation results, are output to the control unit CTRL2 as differential base voltage values ΔVbase[1,2] and ΔVbase[1,3], respectively (which are an example of a “differential base output value” according to the present disclosure). The control unit CTRL2 acquires the differential base voltage values ΔVbase[1,2] and ΔVbase[1,3]. The differential base voltage values are represented by the following Formulae (17) and (18).

$$[ Math . 6 ]$$

$$Δ Vbase [ 1 , 2 ] = Vm 2 - Vm 1 = ( - \frac{R R ( 2 )}{R S ( 1 , 2 )} + \frac{R R ( 1 )}{RS ( 1 , 1 )} - \frac{R R ( 2 )}{RS ( 2 , 2 )} + \frac{R R ( 1 )}{R S ( 2 , 1 )} - \frac{R R ( 2 )}{R S ( 3 , 2 )} + \frac{R R ( 1 )}{RS ( 3 , 1 )} ) \times V 1 a \qquad ( 17 )$$

$$Δ Vbase [ 1 , 3 ] = Vm 3 - Vm 1 = ( - \frac{RR ( 3 )}{R S ( 1 , 3 )} + \frac{R R ( 1 )}{RS ( 1 , 1 )} - \frac{RR ( 3 )}{RS ( 2 , 3 )} + \frac{R R ( 1 )}{R S ( 2 , 1 )} - \frac{RR ( 3 )}{R S ( 3 , 3 )} + \frac{R R ( 1 )}{RS ( 3 , 1 )} ) \times V 1 a \qquad ( 18 )$$

Next, as in step S41 shown in FIG. 6, the control unit CTRL2 performs opening and closing control on the switches SW1(1) to SW1(3) and the switches SW2(1) to SW2(3), applies the potential V1a+V2 to the row line Ai for setting i (i=1), and applies the potential V1a to the row lines A other than the row line for setting i, thereby performing an operation corresponding to the “measurement operation” of step S40 shown in FIGS. 3 and 6. At this time, the output voltage Vm1 from the operational amplifier OP(1) (i.e., the output corresponding to the blind cells) and the output voltages Vm2 and Vm3 from the operational amplifiers OP(2) and OP(3) (i.e., the outputs corresponding to the active cells) are represented by the following Formulae (19) to (21).

$$[ Math . 7 ]$$

$$Vm 1 = - \frac{R R ( 1 )}{RS ( 1 , 1 )} \times ( V 1 a + V 2 ) - \frac{R R ( 1 )}{R S ( 2 , 1 )} \times V 1 a - \frac{R R ( 1 )}{R S ( 3 , 1 )} \times V 1 a \qquad ( 19 )$$

$$Vm 2 = - \frac{R R ( 2 )}{RS ( 1 , 2 )} \times ( V 1 a + V 2 ) - \frac{R R ( 2 )}{R S ( 2 , 2 )} \times V1a - \frac{R R ( 2 )}{R S ( 3 , 2 )} \times V 1 a \qquad ( 20 )$$

$$Vm 3 = - \frac{R R ( 3 )}{R S ( 1 , 3 )} \times ( V 1 a + V 2 ) - \frac{R R ( 3 )}{R S ( 2 , 3 )} \times V 1 a - \frac{R R ( 3 )}{R S ( 3.3 )} \times V 1 a \qquad ( 21 )$$

The voltages Vm2 and Vm3 are the voltage values output via the column lines B2 and B3, respectively (which are an example of a “first measured output value” according to the present disclosure), and the voltage Vm1 is the voltage value output via the column line B1 (which is an example of a “second measured output value” according to the present disclosure). Further, instead of step S42 shown in FIG. 6, the output voltages Vm1 to Vm3 are input to the subtraction circuits Sub(2) and Sub(3). The differential voltages Vm2−Vm1 and Vm3−Vm1, which are computation results, are output to the control unit CTRL2 as differential measured voltage values ΔVmeas[1,2] and ΔVmeas[1,3], respectively (which are an example of a “differential measured output value” according to the present disclosure). The control unit CTRL2 acquires the differential measured voltage values ΔVmeas[1, 2] and ΔVmeas[1, 3]. These differential measured voltage values are represented by the following Formulae (22) and (23).

$$[ Math . 8 ]$$

$$Δ Vmeas [ 1 , 2 ] = Vm 2 - Vm 1 = ( - \frac{RR ( 2 )}{RS ( 1 , 2 )} + \frac{RR ( 1 )}{RS ( 1 , 1 )} ) \times V 2 + ( - \frac{RR ( 2 )}{RS ( 1 , 2 )} + \frac{RR ( 1 )}{RS ( 1 , 1 )} - \frac{RR ( 2 )}{RS ( 2 , 2 )} + \frac{RR ( 1 )}{RS ( 2 , 1 )} - \frac{RR ( 2 )}{RS ( 3 , 2 )} + \frac{RR ( 1 )}{RS ( 3 , 1 )} ) \times V 1 a \qquad ( 22 )$$

$$Δ Vmeas [ 1 , 3 ] = Vm 3 - Vm 1 = ( - \frac{RR ( 3 )}{RS ( 1 , 3 )} + \frac{RR ( 1 )}{RS ( 1 , 1 )} ) \times V 2 + ( - \frac{RR ( 3 )}{RS ( 1 , 3 )} + \frac{RR ( 1 )}{RS ( 1 , 1 )} - \frac{RR ( 3 )}{RS ( 2 , 3 )} + \frac{RR ( 1 )}{RS ( 2 , 1 )} - \frac{RR ( 3 )}{RS ( 3 , 3 )} + \frac{RR ( 1 )}{RS ( 3 , 1 )} ) \times V 1 a \qquad ( 23 )$$

Then, as the “measured output value correction operation” of step S50 shown in FIGS. 3 and 7, the control unit CTRL2 obtains the difference between the differential measured voltage value ΔVmeas[1,2] and the differential base voltage value ΔVbase[1,2] and the difference between the differential measured voltage value ΔVmeas[1,3] and the differential base voltage value ΔVbase[1,3], thereby calculating net voltage values Vcorr[1,2] and Vcorr[1,3]. These net voltage values are represented by the following Formulae (24) and (25).

$$[ Math . 9 ]$$

$$Vcorr [ 1 , 2 ] = Δ Vmeas [ 1 , 2 ] - Δ Vbase [ 1 , 2 ] = \{ ( - \frac{RR ( 2 )}{RS ( 1 , 2 )} + \frac{RR ( 1 )}{RS ( 1 , 1 )} ) \times V 2 + ( - \frac{RR ( 2 )}{RS ( 1 , 2 )} + \frac{RR ( 1 )}{RS ( 1 , 1 )} - \frac{RR ( 2 )}{RS ( 2 , 2 )} + \frac{RR ( 1 )}{RS ( 2 , 1 )} - \frac{RR ( 2 )}{RS ( 3 , 2 )} + \frac{RR ( 1 )}{RS ( 3 , 1 )} ) \times V 1 a \} - ( - \frac{RR ( 2 )}{RS ( 1 , 2 )} + \frac{RR ( 1 )}{RS ( 1 , 1 )} - \frac{RR ( 2 )}{RS ( 2 , 2 )} + \frac{RR ( 1 )}{RS ( 2 , 1 )} - \frac{RR ( 2 )}{RS ( 3 , 2 )} + \frac{RR ( 1 )}{RS ( 3 , 1 )} ) \times V 1 a = ( - \frac{RR ( 2 )}{RS ( 1 , 2 )} + \frac{RR ( 1 )}{RS ( 1 , 1 )} ) \times V 2 \qquad ( 24 )$$

$$Vcorr [ 1 , 3 ] = Δ Vmeas [ 1 , 3 ] - Δ Vbase [ 1 , 3 ] = \{ ( - \frac{RR ( 3 )}{RS ( 1 , 3 )} + \frac{RR ( 1 )}{RS ( 1 , 1 )} ) \times V 2 + ( - \frac{RR ( 3 )}{RS ( 1 , 3 )} + \frac{RR ( 1 )}{RS ( 1 , 1 )} - \frac{RR ( 3 )}{RS ( 2 , 3 )} + \frac{RR ( 1 )}{RS ( 2 , 1 )} - \frac{RR ( 3 )}{RS ( 3 , 3 )} + \frac{RR ( 1 )}{RS ( 3 , 1 )} ) \times V 1 a \} - ( - \frac{RR ( 3 )}{RS ( 1 , 3 )} + \frac{RR ( 1 )}{RS ( 1 , 1 )} - \frac{RR ( 3 )}{RS ( 2 , 3 )} + \frac{RR ( 1 )}{RS ( 2 , 1 )} - \frac{RR ( 3 )}{RS ( 3 , 3 )} + \frac{RR ( 1 )}{RS ( 3 , 1 )} ) \times V 1 a = ( - \frac{RR ( 3 )}{RS ( 1 , 3 )} + \frac{RR ( 1 )}{RS ( 1 , 1 )} ) \times V 2 \qquad ( 25 )$$

As described above, each of the net voltage values Vcorr[1,2] and Vcorr[1,3] represents only the difference component between the thermistor elements SC(1, 2) and SC(1, 3), which are active cells, and the thermistor element SC(1, 1), which is a blind cell. As a result, it is possible to obtain an output in which the influence of the ambient temperature and the sense current has been canceled out.

### Eighth Example Embodiment

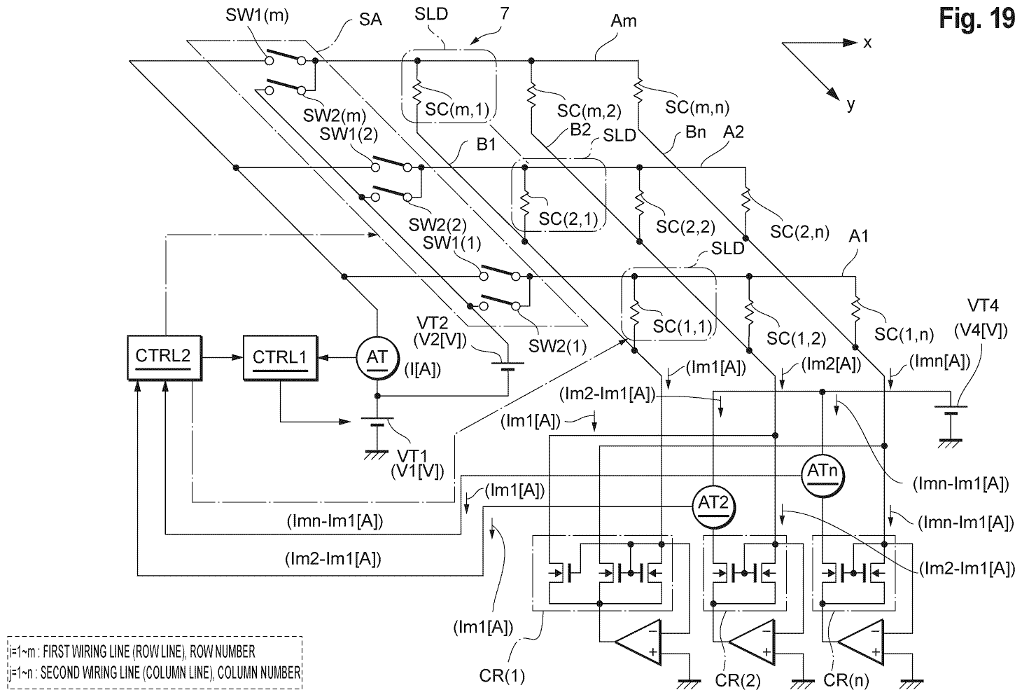

FIG. 19 is a circuit diagram schematically showing an example of the configuration of the element array circuit according to an eighth example embodiment of the present disclosure. The element array circuit 7 is configured in the same manner as the element array circuit 6 shown in FIG. 18, except that it includes current mirror circuits CR(1) to CR(n) and ammeters AT2 to ATn connected between the current mirror circuits CR(2) to CR(n) and the control unit CTRL2 instead of the operational amplifiers OP(1) to OP(n) and the subtraction circuits Sub(2) to Sub(n), and that it includes a power supply VT4 that applies a potential of V4 such that one of the two transistors constituting each of the current mirror circuits CR(2) to CR(n) operates in the saturation region.

In the element array circuit 7 configured in this manner, the current mirror circuits CR(1) to CR(n) disposed as shown in the figure output to the control unit CTRL2 the differential currents between the output currents from the column line B corresponding to the thermistor elements SC(active cells) not covered with the shields SLD and the output current from the column line B corresponding to the thermistor elements SC(blind cells) covered with the shields SLD.

Hereinafter, as an example of the operation of the element array circuit 7, a circuit operation will be described in which measurement is performed using the thermistor elements SC(1, 2) and SC(1, 3), which are connected to the row line A1, in an array of the thermistor elements SC(i, j) arranged in 3 rows and 3 columns (m=3, n=3).

Here, in step S30 shown in FIGS. 3 and 5, the control unit CTRL2 first performs a “base correction value acquisition operation” (which are an example of a “base output value acquisition operation” according to the present disclosure) instead of the “base voltage value acquisition operation.” Here, the control unit CTRL2 first turns on the switches SW1(1) to SW1(3), turns off the switches SW2(1) to SW2(m), and applies the adjusted potential V1a to all the row lines A1 to A3 from the power supply VT1, as in step S31 shown in FIG. 5. At this time, the output current Im1 from the column line B1 (i.e., the output corresponding to the blind cells) and the output currents Im2 and Im3 from the column lines B2 and B3 (i.e., the outputs corresponding to the active cells) are represented by the following Formulae (26) to (28).

$$[ Math . 10 ]$$

$$Im 1 = - \frac{1}{RS ( 1 , 1 )} \times V 1 a - \frac{1}{RS ( 2 , 1 )} \times V 1 a - \frac{1}{RS ( 3 , 1 )} \times V 1 a \qquad ( 26 )$$

$$Im 2 = - \frac{1}{RS ( 1 , 2 )} \times V 1 a - \frac{1}{RS ( 2 , 2 )} \times V 1 a - \frac{1}{RS ( 3 , 2 )} \times V 1 a \qquad ( 27 )$$

$$Im 3 = - \frac{1}{RS ( 1 , 3 )} \times V 1 a - \frac{1}{RS ( 2 , 3 )} \times V 1 a - \frac{1}{RS ( 3 , 3 )} \times V 1 a \qquad ( 28 )$$

The output currents Im2 and Im3 are the current values output via the column lines B2 and B3, respectively (which are an example of a “first base output value” according to the present disclosure), and the output current Im1 is the current value output via the column line B1 (which are an example of the “second base output value” according to the present disclosure). Further, instead of step S32 shown in FIG. 5, the output current Im1 among these output currents Im1 to Im3 is input to the current mirror circuit CR(1), and the output currents Im2 and Im3 are input to the current mirror circuits CR(2) and CR(3), respectively, together with an output current of −Im1 from the current mirror circuit CR(1). That is, a differential current of Im2−Im1 is input to the current mirror circuit CR(2), and a differential current of Im3−Im1 is input to the current mirror circuit CR(3). Then, the ammeters AT2 and AT3 output the differential currents Im2−Im1 and Im3−Im1 to the control unit CTRL2 as the differential base current values ΔIbase[1, 2] and ΔIbase[1, 3], respectively (which are an example of a “differential base output value” according to the present disclosure), and the control unit CTRL2 acquires the differential base current values ΔIbase[1, 2] and ΔIbase[1, 3]. The differential base current values are represented by the following Formulae (29) and (30).

$$[ Math . 11 ]$$

$$Δ Ibase [ 1 , 2 ] = Im 2 - Im 1 = ( - \frac{1}{RS ( 1 , 2 )} + \frac{1}{RS ( 1 , 1 )} - \frac{1}{RS ( 2 , 2 )} + \frac{1}{RS ( 2 , 1 )} - \frac{1}{RS ( 3 , 2 )} + \frac{1}{RS ( 3 , 1 )} ) \times V 1 a \qquad ( 29 )$$

$$Δ Ibase [ 1 , 3 ] = Im 3 - Im 1 = ( - \frac{1}{RS ( 1 , 3 )} + \frac{1}{RS ( 1 , 1 )} - \frac{1}{RS ( 2 , 3 )} + \frac{1}{RS ( 2 , 1 )} - \frac{1}{RS ( 3 , 3 )} + \frac{1}{RS ( 3 , 1 )} ) \times V 1 a \qquad ( 30 )$$

Next, as in step S41 shown in FIG. 6, the control unit CTRL2 performs opening and closing control on the switches SW1(1) to SW1(3) and the switches SW2(1) to SW2(3), applies the potential V1a+V2 to the row line Ai for setting i (i=1), and applies the potential V1a to the row lines A other than the row line for setting i, thereby performing an operation corresponding to the “measurement operation” of step S40 shown in FIGS. 3 and 6. At this time, the output current Im1 from the column line B1 (i.e., the output corresponding to the blind cells) and the output currents Im2 and Im3 from the column lines B2 and B3 (i.e., the outputs corresponding to the active cells) are represented by the following Formulae (31) to (33).

$$[ Math . 12 ]$$

$$Im 1 = - \frac{1}{RS ( 1 , 1 )} \times ( V 1 a + V 2 ) - \frac{1}{RS ( 2 , 1 )} \times V 1 a - \frac{1}{RS ( 3 , 1 )} \times V 1 a \qquad ( 31 )$$

$$Im 2 = - \frac{1}{RS ( 1 , 2 )} \times ( V 1 a + V 2 ) - \frac{1}{RS ( 2 , 2 )} \times V 1 a - \frac{1}{RS ( 3 , 2 )} \times V 1 a \qquad ( 32 )$$

$$Im 3 = - \frac{1}{RS ( 1 , 3 )} \times ( V 1 a + V 2 ) - \frac{1}{RS ( 2 , 3 )} \times V 1 a - \frac{1}{RS ( 3 , 3 )} \times V 1 a \qquad ( 33 )$$

The output currents Im2 and Im3 are the current values output via the column lines B2 and B3, respectively (which are an example of a “first measured output value” according to the present disclosure), and the output current Im1 is the current value output via the column line B1 (which is an example of a “second measured output value” according to the present disclosure). Further, instead of step S42 shown in FIG. 6, the output current Im1 among these output currents Im1 to Im3 is input to the current mirror circuit CR(1), and the output currents Im2 and Im3 are input to the current mirror circuits CR(2) and CR(3), respectively, together with the output current −Im1 from the current mirror circuit CR(1). That is, the differential current of Im2−Im1 is input to the current mirror circuit CR(2), and the differential current Im3−Im1 is input to the current mirror circuit CR(3). Then, the ammeters AT2 and AT3 output the differential currents Im2−Im1 and Im3−Im1 to the control unit CTRL2 as differential measured output current values ΔImeas[1,2] and ΔImeas[1,3], respectively (which are an examples of a “differential measured output value” according to the present disclosure). The control unit CTRL2 acquires the differential measured current values ΔImeas[1,2] and ΔImeas[1,3]. The differential measured current values are represented by the following Formulae (34) and (35).

$$[ Math . 13 ]$$

$$Δ Imeas [ 1 , 2 ] = Im 2 - Im 1 = ( - \frac{1}{RS ( 1 , 2 )} + \frac{1}{RS ( 1 , 1 )} ) \times V 2 + ( - \frac{1}{RS ( 1 , 2 )} + \frac{1}{RS ( 1 , 1 )} - \frac{1}{RS ( 2 , 2 )} + \frac{1}{RS ( 2 , 1 )} - \frac{1}{RS ( 3 , 2 )} + \frac{1}{RS ( 3 , 1 )} ) \times V 1 a \qquad ( 34 )$$

$$Δ Imeas [ 1 , 3 ] = Im 3 - Im 1 = ( - \frac{1}{RS ( 1 , 3 )} + \frac{1}{RS ( 1 , 1 )} ) \times V 2 + ( - \frac{1}{RS ( 1 , 3 )} + \frac{1}{RS ( 1 , 1 )} - \frac{1}{RS ( 2 , 3 )} + \frac{1}{RS ( 2 , 1 )} - \frac{1}{RS ( 3 , 3 )} + \frac{1}{RS ( 3 , 1 )} ) \times V 1 a \qquad ( 35 )$$

Then, as the “measured output value correction operation” of step S50 shown in FIGS. 3 and 7, the control unit CTRL2 obtains the difference between the differential measured current value ΔImeas1[1,2] and the differential base current value ΔIbase[1,2] and the difference between the differential measured current value ΔImeas1[1,3] and the differential base current value ΔIbase[1,3], thereby calculating net current values Icorr[1,2] and Icorr[1,3]. These net current values are represented by the following Formulae (36) and (37).

$$[ Math . 14 ]$$

$$Icorr [ 1 , 2 ] = Δ Imeas [ 1 , 2 ] - Δ Ibase [ 1 , 2 ] = \{ ( - \frac{1}{RS ( 1 , 2 )} + \frac{1}{RS ( 1 , 1 )} ) \times V 2 + ( - \frac{1}{RS ( 1 , 2 )} + \frac{1}{RS ( 1 , 1 )} - \frac{1}{RS ( 2 , 2 )} + \frac{1}{RS ( 2 , 1 )} - \frac{1}{RS ( 3 , 2 )} + \frac{1}{RS ( 3 , 1 )} ) \times V 1 a \} - ( - \frac{1}{RS ( 1 , 2 )} + \frac{1}{RS ( 1 , 1 )} - \frac{1}{RS ( 2 , 2 )} + \frac{1}{RS ( 2 , 1 )} - \frac{1}{RS ( 3 , 2 )} + \frac{1}{RS ( 3 , 1 )} ) \times V 1 a = ( - \frac{1}{RS ( 1 , 2 )} + \frac{1}{RS ( 1 , 1 )} ) \times V 2 \qquad ( 36 )$$

$$Icorr [ 1 , 3 ] = Δ Imeas [ 1 , 3 ] - Δ Ibase [ 1 , 3 ] = \{ ( - \frac{1}{RS ( 1 , 3 )} + \frac{1}{RS ( 1 , 1 )} ) \times V 2 + ( - \frac{1}{RS ( 1 , 3 )} + \frac{1}{RS ( 1 , 1 )} - \frac{1}{RS ( 2 , 3 )} + \frac{1}{RS ( 2 , 1 )} - \frac{1}{RS ( 3 , 3 )} + \frac{1}{RS ( 3 , 1 )} ) \times V 1 a \} - ( - \frac{1}{RS ( 1 , 3 )} + \frac{1}{RS ( 1 , 1 )} - \frac{1}{RS ( 2 , 3 )} + \frac{1}{RS ( 2 , 1 )} - \frac{1}{RS ( 3 , 3 )} + \frac{1}{RS ( 3 , 1 )} ) \times V 1 a = ( - \frac{1}{RS ( 1 , 3 )} + \frac{1}{RS ( 1 , 1 )} ) \times V 2 \qquad ( 37 )$$

As described above, each of the net current values Icorr[1,2] and Icorr[1,3] represents only the difference component between the thermistor elements SC(1, 2) and SC(1, 3), which are active cells, and the thermistor element SC(1, 1), which is a blind cell. As a result, it is possible to obtain an output in which the influence of the ambient temperature and the sense current has been canceled out.

### Ninth Example Embodiment

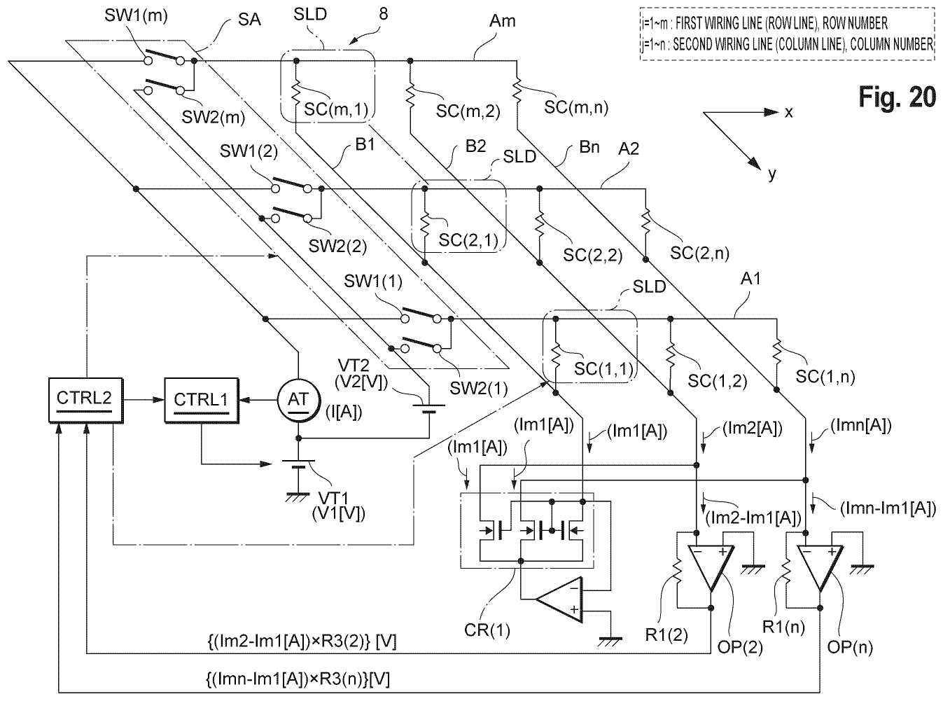

FIG. 20 is a circuit diagram schematically showing an example of the configuration of the element array circuit according to a ninth example embodiment of the present disclosure. The element array circuit 8 is configured in the same manner as the element array circuit 6 shown in FIG. 18, except that it includes the current mirror circuit CR(1) instead of the operational amplifier OP(1) and the subtraction circuits Sub(2) to Sub(n), and currents representing the differences between the output currents from the column lines B2 to Bn and the output current from the current mirror circuit CR(1) are input to the respective negative input terminals of the operational amplifiers OP(2) to OP(n).

In the element array circuit 8 configured in this manner, the current mirror circuit CR(1) and the operational amplifiers OP(2) to OP(n), which are disposed as shown in the figure, output to the control unit CTRL2 voltages converted from the differential currents between the output currents from the column lines B corresponding to the thermistor elements SC (active cells) not covered with the shields SLD and the output current from the column line B corresponding to the thermistor elements SC (blind cells) covered with the shields SLD.

Hereinafter, as an example of the operation of the element array circuit 8, a circuit operation will be described in which measurement is performed using the thermistor elements SC(1, 2) and SC(1, 3), which are connected to the row line A1, in an array of the thermistor elements SC(i, j) arranged in 3 rows and 3 columns (m=3, n=3).

Here, in step S30 shown in FIGS. 3 and 5, the control unit CTRL2 first performs the “base correction value acquisition operation” (which is an example of a “base output value acquisition operation” according to the present disclosure) instead of the “base voltage value acquisition operation.” Here, the control unit CTRL2 first turns on the switches SW1(1) to SW1(3), turns off the switches SW2(1) to SW2(m), and applies the adjusted potential V1a to all the row lines A1 to A3 from the power supply VT1, as in step S31 shown in FIG. 5. At this time, the output current Im1 from the column line B1 (i.e., the output corresponding to the blind cells) and the output currents Im2 and Im3 from the column lines B2 and B3 (i.e., the outputs corresponding to the active cells) are represented by the following Formulae (26) to (28) (which will be described below again).

$$[ Math . 15 ]$$

$$Im 1 = - \frac{1}{RS ( 1 , 1 )} \times V 1 a - \frac{1}{RS ( 2 , 1 )} \times V 1 a - \frac{1}{RS ( 3 , 1 )} \times V 1 a \qquad ( 26 )$$

$$Im 2 = - \frac{1}{RS ( 1 , 2 )} \times V 1 a - \frac{1}{RS ( 2 , 2 )} \times V 1 a - \frac{1}{RS ( 3 , 2 )} \times V 1 a \qquad ( 27 )$$

$$Im 3 = - \frac{1}{RS ( 1 , 3 )} \times V 1 a - \frac{1}{RS ( 2 , 3 )} \times V 1 a - \frac{1}{RS ( 3 , 3 )} \times V 1 a \qquad ( 28 )$$

Further, instead of step S32 shown in FIG. 5, the output current Im1 among these output currents Im1 to Im3 is input to the current mirror circuit CR(1), and the output currents Im2 and Im3 are input to the operational amplifiers OP(2) and OP(3), respectively, together with the output current −Im1 from the current mirror circuit CR(1). That is, the differential current of Im2−Im1 is input to the operational amplifier OP(2), and the differential current Im3−Im1 is input to the operational amplifier OP(3). The differential currents Im2−Im1 and Im3−Im1 represent the differences between the current values output via the column lines B2 and B3 (which are an example of a “first base output value” according to the present disclosure) and the current value output via the column line B1 (which is an example of a “second base output value” according to the present disclosure), respectively (differential base current values ΔIbase[1,2] and ΔIbase[1,3]). Then, the operational amplifiers OP(2) and OP(3) convert the differential base current values ΔIbase[1,2] and ΔIbase[1,3] into differential base voltage values ΔVbase[1,2] and ΔVbase[1,3] (which are an example of the “differential base output value” according to the present disclosure), respectively, and output the differential base voltage values to the control unit CTRL2. The control unit CTRL2 acquires the differential base voltage values ΔVbase[1,2] and ΔVbase[1,3]. The differential base voltage value ΔVbase[1,2] is the voltage obtained by multiplying the differential current Im2−Im1 by the resistance value RX(2) of the resistor R1(2), and the differential base voltage value ΔVbase[1,3] is the voltage obtained by multiplying the differential current Im3−Im1 by the resistance value RX(3) of the resistor R1(3). The differential base voltage values are represented by the following Formulae (38) and (39).

$$[ Math . 16 ]$$

$$Δ Vbase [ 1 , 2 ] = ( Im 2 - Im 1 ) \times RX ( 2 ) = ( - \frac{RX ( 2 )}{RS ( 1 , 2 )} + \frac{RX ( 2 )}{RS ( 1 , 1 )} - \frac{RX ( 2 )}{RS ( 2 , 2 )} + \frac{RX ( 2 )}{RS ( 2 , 1 )} - \frac{RX ( 2 )}{RS ( 3 , 2 )} + \frac{RX ( 2 )}{RS ( 3 , 1 )} ) \times V 1 a \qquad ( 38 )$$

$$Δ Vbase [ 1 , 3 ] = ( Im 3 - Im 1 ) \times RX ( 3 ) = ( - \frac{RX ( 3 )}{RS ( 1 , 3 )} + \frac{RX ( 3 )}{RS ( 1 , 1 )} - \frac{RX ( 3 )}{RS ( 2 , 3 )} + \frac{RX ( 3 )}{RS ( 2 , 1 )} - \frac{RX ( 3 )}{RS ( 3 , 3 )} + \frac{RX ( 3 )}{RS ( 3 , 1 )} ) \times V 1 a \qquad ( 39 )$$

Next, as in step S41 shown in FIG. 6, the control unit CTRL2 performs opening and closing control on the switches SW1(1) to SW1(3) and the switches SW2(1) to SW2(3), applies the potential V1a+V2 to the row line Ai for setting i (i=1), and applies the potential V1a to the row lines A other than the row line for setting i, thereby performing an operation corresponding to the “measurement operation” of step S40 shown in FIGS. 3 and 6. At this time, the output current Im1 from the column line B1 (i.e., the output corresponding to the blind cells) and the output currents Im2 and Im3 from the column lines B2 and B3 (i.e., the outputs corresponding to the active cells) are represented by the above Formulae (31) to (33) (which will be described below again).

$$[ Math . 17 ]$$

$$Im 1 = - \frac{1}{RS ( 1 , 1 )} \times ( V 1 a + V 2 ) - \frac{1}{RS ( 2 , 1 )} \times V 1 a - \frac{1}{RS ( 3 , 1 )} \times V 1 a \qquad ( 31 )$$

$$Im 2 = - \frac{1}{RS ( 1 , 2 )} \times ( V 1 a + V 2 ) - \frac{1}{RS ( 2 , 2 )} \times V 1 a - \frac{1}{RS ( 3 , 2 )} \times V 1 a \qquad ( 32 )$$

$$Im 3 = - \frac{1}{RS ( 1 , 3 )} \times ( V 1 a + V 2 ) - \frac{1}{RS ( 2 , 3 )} \times V 1 a - \frac{1}{RS ( 3 , 3 )} \times V 1 a \qquad ( 33 )$$

Further, instead of step S42 shown in FIG. 6, the output current Im1 among these output currents Im1 to Im3 is input to the current mirror circuit CR(1), and the output currents Im2 and Im3 are input to the operational amplifiers OP(2) and OP(3), respectively, together with the output current −Im1 from the current mirror circuit CR(1). That is, the differential current Im2−Im1 is input to the operational amplifier OP(2), and the differential current of Im3−Im1 is input to the operational amplifier OP(3). The differential currents Im2−Im1 and Im3−Im1 represent the differences between the current values output via the column lines B2 and B3 (which are an example of a “first measured output value” according to the present disclosure) and the current value output via the column line B1 (which is an example of a “second measured output value” according to the present disclosure), respectively (differential measured current values ΔImeas[1,2] and ΔImeas[1,3]). Then, the operational amplifiers OP(2) and OP(3) convert the differential measured current values ΔImeas[1,2] and ΔImeas[1,3] into differential measured voltage values ΔVmeas[1,2] and ΔVmeas[1,3] (which are an example of a “differential measured output value” according to the present disclosure), respectively, and output the differential measured voltage values to the control unit CTRL2. The control unit CTRL2 acquires the differential measured voltage values ΔVmeas[1,2] and ΔVmeas[1,3]. The differential measured voltage value ΔVmeas[1,2] is the voltage obtained by multiplying the differential current Im2−Im1 by the resistance value RX(2) of the resistor R1(2), and the differential measured voltage value ΔVmeas[1,3] is the voltage obtained by multiplying the differential current Im3−Im1 by the resistance value RX(3) of the resistor R1(3). The differential measured voltage values are represented by the following Formulae (40) and (41).

$$[ Math . 18 ]$$

$$Δ Vmeas [ 1 , 2 ] = ( Im 2 - Im 1 ) \times RX ( 2 ) = ( - \frac{RX ( 2 )}{RS ( 1 , 2 )} + \frac{RX ( 2 )}{RS ( 1 , 1 )} ) \times V 2 + ( - \frac{RX ( 2 )}{RS ( 1 , 2 )} + \frac{RX ( 2 )}{RS ( 1 , 1 )} - \frac{RX ( 2 )}{RS ( 2 , 2 )} + \frac{RX ( 2 )}{RS ( 2 , 1 )} - \frac{RX ( 2 )}{RS ( 3 , 2 )} + \frac{RX ( 2 )}{RS ( 3 , 1 )} ) \times V 1 a \qquad ( 40 )$$

$$Δ Vmeas [ 1 , 3 ] = ( Im 3 - Im 1 ) \times RX ( 3 ) = ( - \frac{RX ( 3 )}{RS ( 1 , 3 )} + \frac{RX ( 3 )}{RS ( 1 , 1 )} ) \times V 2 + ( - \frac{RX ( 3 )}{RS ( 1 , 3 )} + \frac{RX ( 3 )}{RS ( 1 , 1 )} - \frac{RX ( 3 )}{RS ( 2 , 3 )} + \frac{RX ( 3 )}{RS ( 2 , 1 )} - \frac{RX ( 3 )}{RS ( 3 , 3 )} + \frac{RX ( 3 )}{RS ( 3 , 1 )} ) \times V 1 a \qquad ( 41 )$$

Then, as the “measured output value correction operation” of step S50 shown in FIGS. 3 and 7, the control unit CTRL2 obtains the difference between the differential measured voltage value ΔVmeas[1,2] and the differential base voltage value ΔVbase[1,2] and the difference between the differential measured voltage value ΔVmeas[1,3] and the differential base voltage value ΔVbase[1,3], thereby calculating net voltage values Vcorr[1,2] and Vcorr[1,3]. These net voltage values are represented by the following Formulae (42) and (43).

$$[ Math . 19 ]$$

$$Vcorr [ 1 , 2 ] = Δ Vmeas [ 1 , 2 ] - Δ Vbase [ 1 , 2 ] = \{ ( - \frac{RX ( 2 )}{RS ( 1 , 2 )} + \frac{RX ( 2 )}{RS ( 1 , 1 )} ) \times V 2 + ( - \frac{RX ( 2 )}{RS ( 1 , 2 )} + \frac{RX ( 2 )}{RS ( 1 , 1 )} - \frac{RX ( 2 )}{RS ( 2 , 2 )} + \frac{RX ( 2 )}{RS ( 2 , 1 )} - \frac{RX ( 2 )}{RS ( 3 , 2 )} + \frac{RX ( 2 )}{RS ( 3 , 1 )} ) \times V 1 a \} - ( - \frac{RX ( 2 )}{RS ( 1 , 2 )} + \frac{RX ( 2 )}{RS ( 1 , 1 )} - \frac{RX ( 2 )}{RS ( 2 , 2 )} + \frac{RX ( 2 )}{RS ( 2 , 1 )} - \frac{RX ( 2 )}{RS ( 3 , 2 )} + \frac{RX ( 2 )}{RS ( 3 , 1 )} ) \times V 1 a = ( - \frac{RX ( 2 )}{RS ( 1 , 2 )} + \frac{RX ( 2 )}{RS ( 1 , 1 )} ) \times V 2 \qquad ( 42 )$$

$$Vcorr [ 1 , 3 ] = Δ Vmeas [ 1 , 3 ] - Δ Vbase [ 1 , 3 ] = \{ ( - \frac{RX ( 3 )}{RS ( 1 , 3 )} + \frac{RX ( 3 )}{RS ( 1 , 1 )} ) \times V 2 + ( - \frac{RX ( 3 )}{RS ( 1 , 3 )} + \frac{RX ( 3 )}{RS ( 1 , 1 )} - \frac{RX ( 3 )}{RS ( 2 , 3 )} + \frac{RX ( 3 )}{RS ( 2 , 1 )} - \frac{RX ( 3 )}{RS ( 3 , 3 )} + \frac{RX ( 3 )}{RS ( 3 , 1 )} ) \times V 1 a \} - ( - \frac{RX ( 3 )}{RS ( 1 , 3 )} + \frac{RX ( 3 ) 1}{RS ( 1 , 1 )} - \frac{RX ( 3 )}{RS ( 2 , 3 )} + \frac{RX ( 3 )}{RS ( 2 , 1 )} - \frac{RX ( 3 )}{RS ( 3 , 3 )} + \frac{RX ( 3 )}{RS ( 3 , 1 )} ) \times V 1 a = ( - \frac{RX ( 3 )}{RS ( 1 , 3 )} + \frac{RX ( 3 )}{RS ( 1 , 1 )} ) \times V 2 \qquad ( 43 )$$

As described above, each of the net voltage values Vcorr[1,2] and Vcorr[1,3] represents only the difference component between the thermistor elements SC(1, 2) and SC(1, 3), which are active cells, and the thermistor element SC(1, 1), which is a blind cell. As a result, it is possible to obtain an output in which the influence of the ambient temperature and the sense current has been canceled out.

### Tenth Example Embodiment

In the element array circuits 1 to 8 (except for the element array circuit 3) of the example embodiments described above, a configuration may be adopted in which only one row line A1 is provided as the row line Ai. In this case, in relation to the thermistor elements SC(i, j), only the thermistor elements SC(l, j) corresponding to the row line A1 are provided, and the row line selection unit SA has only the single switch SW1(1) and the single switch SW2(1). Each element array circuit having such a configuration may perform procedures in accordance with the operation procedures shown in FIGS. 3 to 7, except that the row line Ai is not selected.

For example, as the operation procedure when the element array circuit 1 (FIG. 1) according to the first example embodiment has only the single row line A1, the “initializing operation” is first performed in step S10 shown in FIG. 3. Then, in step S20, the “temperature control operation” is performed on the thermistor elements SC(1, j). Next, in step S30, the “base voltage value acquisition operation” is performed in a state in which the adjusted potential V1a is applied to the row line A1 to acquire correction base voltage values Vbase(j) for the thermistor elements SC(1, j). Subsequently, in step S40, the “measurement operation” is performed in a state in which the V1a+V2 is applied to the row line A1 from the power supplies VT1 and VT2 to acquire measured voltage values Vmeas1(1, j) corresponding to the thermistor elements SC(1, j). Then, in step S50, the “measured output value correction operation” is performed as computation processing to calculate a net voltage value Vcorr(1, j) that may be output corresponding to each thermistor element SC(1, j) when the potential V2 is applied to the row line A1 (see the above Formula (4)).

Alternatively, as the operation procedure when the element array circuit 6 (FIG. 18) according to the seventh example embodiment has only the single row line A1, the “initializing operation” is first performed in step S10 shown in FIG. 3. Then, in step S20, the “temperature control operation” is performed on the thermistor elements SC(1, 1) to SC(1, n). Next, in step S30, the “base correction value acquisition operation” is performed in a state in which the adjusted potential V1a is applied to the row line A1 to acquire differential base voltage values ΔVbase[1, j] (j≥2) for the thermistor elements SC(1, j). Subsequently, in step S40, an operation corresponding to the “measurement operation” is performed in a state in which the potential V1a+V2 is applied to the row line A1 from the power supplies VT1 and VT2 to acquire differential measured voltage values ΔVmeas[1, j](j≥2). Then, in step S50, the “measured output value correction operation” is performed as computation processing to calculate a net voltage value Vcorr(1, j)(j≥2) that may be output corresponding to each thermistor element SC(1, j) (j≥2) when the potential V2 is applied to the row line A1 (see the above Formulae (24) and (25)).

Each example embodiment has been described above with reference to the specific examples to facilitate understanding of the present disclosure, but it is not intended to limit the interpretation of the present disclosure. That is, the present disclosure is not limited to these specific examples, and modifications appropriately made to these specific examples by persons skilled in the art may also fall within the technical scope of the present disclosure, as long as they include the features of the present disclosure. Furthermore, the elements, arrangements, materials, conditions, shapes, dimensions, scales, and the like provided in the specific examples described above are not limited to those illustrated unless otherwise specifically indicated, and may be appropriately modified. In addition, the combinations of the elements provided in the specific examples described may also be appropriately changed, as long as no technical contradictions arise. That is, for example, the numbers of the row lines Ai and the column lines Bj are not particularly limited and may be arbitrarily set. For example, the column lines Bj may include a single column line rather than column lines. Furthermore, for example, the number of the operational amplifiers OP may be smaller than that of the column lines Bj, and a configuration may be adopted in which an appropriate switch sequentially connects the column lines B(j) to the negative input terminal of one operational amplifier OP one by one.

Furthermore, the power supplies VT1 and VT2 may be provided inside or outside the element array circuit 1. In addition, capacitors (capacitance elements) connected in parallel to the operational amplifiers OP(j) similarly to the resistors R1 may be used instead of the resistors R1. In this case, it is also possible to convert the currents flowing through the column lines B(j) into voltages. Furthermore, the “temperature control operation” performed in step S20 may use, instead of the current values of the currents flowing through the row lines A, outputs corresponding to the current values of the currents flowing through the column lines B (e.g., measured voltages output from the respective operational amplifiers OP or measured values of currents flowing through the respective column lines B). In addition, in step S50, although the computation (“the measured output value correction operation”) shown in Formula (4) is performed after the acquisition of the measured voltage values Vmeas1(i, j) for all the row lines A has been completed, it may instead be performed sequentially as each measured voltage value Vmeas1(i, j) is scanned and acquired. Moreover, in step SCO, the operation of simply converting into temperature data or information on the intensity of electromagnetic waves may be performed instead of the image data conversion operation for converting into image data indicating temperature.

1. An element array circuit comprising:
first wiring lines extending in a first direction;
one or more second wiring lines extending in a second direction;
first thermistor elements, each of which is connected to one of the first wiring lines and to one of the second wiring lines;
a first power supply configured to supply a first potential;
a second power supply configured to supply a second potential different from the first potential; and
a control unit,
wherein
the control unit
as a temperature control operation, maintains the first thermistor elements at a temperature within a specified range, by supplying a current to the first thermistor elements through application of the first potential to the first wiring lines and adjusting the first potential, in a state in which the first thermistor elements are not irradiated with electromagnetic waves from a measurement target,
as a base output value acquisition operation, acquires a base output value output via the second wiring line by applying the adjusted first potential to the first wiring lines, in a state in which the first thermistor elements are irradiated with the electromagnetic waves from the measurement target,
as a measurement operation, acquires a measured output value output via the second wiring line, by applying the second potential to one first wiring line selected from among the first wiring lines and applying the adjusted first potential to the first wiring lines other than the selected one first wiring line, in a state in which the first thermistor elements are irradiated with the electromagnetic waves from the measurement target, and
as a measured output value correction operation, obtains a difference between the measured output value and the base output value.

2. An element array circuit comprising:
one first wiring line extending in a first direction;
one or more second wiring lines extending in a second direction;
one or more first thermistor elements, each of which is connected to the one first wiring line and to one of the second wiring lines;
a first power supply configured to supply a first potential;
a second power supply configured to supply a second potential different from the first potential; and
a control unit,
wherein
the control unit
as a temperature control operation, maintains the first thermistor elements at a temperature within a specified range, by supplying a current to the first thermistor elements through application of the first potential to the one first wiring line and adjusting the first potential, in a state in which the first thermistor elements are not irradiated with electromagnetic waves from a measurement target,
as a base output value acquisition operation, acquires a base output value output via the second wiring line, by applying the adjusted first potential to the one first wiring line, in a state in which the first thermistor elements are irradiated with the electromagnetic waves from the measurement target,
as a measurement operation, acquires a measured output value output via the second wiring line, by applying the second potential to the one first wiring line, in a state in which the first thermistor elements are irradiated with the electromagnetic waves from the measurement target, and
as a measured output value correction operation, obtains a difference between the measured output value and the base output value.

3. The element array circuit according to claim 1, wherein
the second power supply comprises the first power supply and another power supply that is connected, in series, with the first power supply.

4. The element array circuit according to claim 2, wherein
the second power supply comprises the first power supply and another power supply that is connected, in series, with the first power supply.

5. The element array circuit according to claim 1, wherein
the first power supply and the second power supply are provided for each of the first wiring lines, and
the control unit, as the temperature control operation, maintains the first thermistor elements at the temperature within the specified range by adjusting the first potential for each of the first wiring lines.

6. An element array circuit comprising:
first wiring lines extending in a first direction;
one or more second wiring lines extending in a second direction;
a third wiring line extending in the second direction;
first thermistor elements, each of which is connected to one of the first wiring lines and to one of the second wiring lines;
second thermistor elements, each of which is connected to one of the first wiring lines and to the third wiring line and is shielded from electromagnetic waves from a measurement target;
a first power supply configured to supply a first potential;
a second power supply configured to supply a second potential different from the first potential; and
a control unit,
wherein
the control unit
as a temperature control operation, maintains the first thermistor elements and the second thermistor elements at a temperature within a specified range, by supplying a current to the first thermistor elements and the second thermistor elements through application of the first potential to the first wiring lines and adjusting the first potential, in a state in which the first thermistor elements are not irradiated with the electromagnetic waves from the measurement target,
as a base output value acquisition operation, acquires a differential base output value resulting from a difference between a first base output value output via the second wiring line and a second base output value output via the third wiring line, by applying the adjusted first potential to the first wiring lines, in a state in which the first thermistor elements are irradiated with the electromagnetic waves from the measurement target,
as a measurement operation, acquires a differential measured output value resulting from a difference between a first measured output value output via the second wiring line and a second measured output value output via the third wiring line, by applying the second potential to one first wiring line selected from among the first wiring lines and applying the adjusted first potential to the first wiring lines other than the selected one first wiring line, in a state in which the first thermistor elements are irradiated with the electromagnetic waves from the measurement target, and
as a measured output value correction operation, obtains a difference between the differential measured output value and the differential base output value.

7. An element array circuit comprising:
one first wiring line extending in a first direction;
one or more second wiring lines extending in a second direction;
a third wiring line extending in the second direction;
one or more first thermistor elements, each of which is connected to the one first wiring line and to one of the second wiring lines;
a second thermistor element that is connected to the one first wiring line and the third wiring line and is shielded from electromagnetic waves from a measurement target;
a first power supply configured to supply a first potential;
a second power supply configured to supply a second potential different from the first potential; and
a control unit,
wherein
the control unit
as a temperature control operation, maintains the first thermistor elements and the second thermistor element at a temperature within a specified range, by supplying a current to the first thermistor elements and the second thermistor element through application of the first potential to the one first wiring line and adjusting the first potential, in a state in which the first thermistor elements are not irradiated with the electromagnetic waves from the measurement target,
as a base output value acquisition operation, acquires a differential base output value resulting from a difference between a first base output value output via the second wiring line and a second base output value output via the third wiring line, by applying the adjusted first potential to the one first wiring line, in a state in which the first thermistor elements are irradiated with the electromagnetic waves from the measurement target,
as a measurement operation, acquires a differential measured output value resulting from a difference between a first measured output value output via the second wiring line and a second measured output value output via the third wiring line, by applying the second potential to the one first wiring line, in a state in which the first thermistor elements are irradiated with the electromagnetic waves from the measurement target, and
as a measured output value correction operation, obtains a difference between the differential measured output value and the differential base output value.

8. The element array circuit according to claim 1, further comprising:
a third wiring line extending in the first direction;
one or more second thermistor elements, each of which is connected to one of the second wiring lines and to the third wiring line and is shielded from the electromagnetic waves from the measurement target; and
a third power supply configured to supply a third potential,
wherein
a polarity of a potential difference obtained by subtracting the first potential from the second potential is opposite to a polarity of a potential difference obtained by subtracting the first potential from the third potential, and
the control unit
as the temperature control operation, maintains the second thermistor elements at a temperature within the specified range, by supplying a current to the second thermistor elements through application of the first potential to the third wiring line and adjusting the first potential,
as the base output value acquisition operation, acquires the base output value output via the second wiring line, by applying the adjusted first potential to the third wiring line, and
as the measurement operation, acquires the measured output value output via the second wiring line, by applying the third potential to the third wiring line.

9. The element array circuit according to claim 2, further comprising:
a third wiring line extending in the first direction;
one or more second thermistor elements, each of which is connected to one of the second wiring lines and to the third wiring line and is shielded from the electromagnetic waves from the measurement target; and
a third power supply configured to supply a third potential,
wherein
a polarity of a potential difference obtained by subtracting the first potential from the second potential is opposite to a polarity of a potential difference obtained by subtracting the first potential from the third potential, and
the control unit
as the temperature control operation, maintains the second thermistor elements at a temperature within the specified range, by supplying a current to the second thermistor elements through application of the first potential to the third wiring line and adjusting the first potential,
as the base output value acquisition operation, acquires the base output value output via the second wiring line, by applying the adjusted first potential to the third wiring line, and
as the measurement operation, acquires the measured output value output via the second wiring line, by applying the third potential to the third wiring line.

10. The element array circuit according to claim 8, wherein
the third power supply comprises the first power supply and another power supply that is connected, in series, with the first power supply.

11. The element array circuit according to claim 9, wherein
the third power supply comprises the first power supply and another power supply that is connected, in series, with the first power supply.

12. The element array circuit according to claim 1, wherein
the control unit
as an offset voltage value acquisition operation, calculates an offset output value that represents a difference between each reference output value and an average value of all the reference output values by performing, for each of the first wiring lines, application of the second potential to the one first wiring line selected from among the first wiring lines, application of the adjusted first potential to the first wiring lines other than the selected one first wiring line, and acquisition of a reference output value output via the second wiring line in a state in which the first thermistor elements are irradiated with electromagnetic waves from a reference object having a substantially uniform temperature, and
as the measured output value correction operation, corrects the difference between the measured output value and the base output value by using the offset output value.

13. The element array circuit according to claim 1, further comprising:
resistors, each of which is connected, in series, with a corresponding one of the first thermistor elements and is also connected to a corresponding one of the first wiring lines and a corresponding one of the second wiring lines.

14. An electromagnetic wave sensor comprising:
the element array circuit according to claim 1; and
a shutter that switches between irradiation and non-irradiation of the first thermistor elements with the electromagnetic waves from the measurement target.

15. An electromagnetic wave sensor comprising:
the element array circuit according to claim 2; and
a shutter that switches between irradiation and non-irradiation of the first thermistor element with the electromagnetic waves from the measurement target.

16. An electromagnetic wave sensor comprising:
the element array circuit according to claim 6; and
a shutter that switches between irradiation and non-irradiation of the first thermistor elements with the electromagnetic waves from the measurement target.

17. An electromagnetic wave sensor comprising:
the element array circuit according to claim 7; and
a shutter that switches between irradiation and non-irradiation of the first thermistor element with the electromagnetic waves from the measurement target.

18. A method for controlling an element array circuit including
first wiring lines extending in a first direction,
one or more second wiring lines extending in a second direction,
first thermistor elements, each of which is connected to one of the first wiring lines and to one of the second wiring lines,
a first power supply configured to supply a first potential,
a second power supply configured to supply a second potential different from the first potential, and
a control unit,
the method comprising, by the control unit:
a temperature control operation of maintaining the first thermistor elements at a temperature within a specified range by supplying a current to the first thermistor elements through application of the first potential to the first wiring lines and adjusting the first potential, in a state in which the first thermistor elements are not irradiated with electromagnetic waves from a measurement target;
a base output value acquisition operation of acquiring a base output value output via the second wiring line by applying the adjusted first potential to the first wiring lines, in a state in which the first thermistor elements are irradiated with the electromagnetic waves from the measurement target;
a measurement operation of acquiring a measured output value output via the second wiring line by applying the second potential to one first wiring line selected from among the first wiring lines and applying the adjusted first potential to the first wiring lines other than the selected one first wiring line, in a state in which the first thermistor elements are irradiated with the electromagnetic waves from the measurement target; and
a measured output value correction operation of obtaining a difference between the measured output value and the base output value.
